(19) United States
(12) Patent Application Publication
(10) Pub. No.: US 2024/0112023 A1
(43) Pub. Date: Apr. 4, 2024

(54) COMPUTING TECHNOLOGIES FOR PRESERVING SIGNALS FOR ARTIFICIAL NEURAL NETWORKS WHEN DOWNSAMPLING

(71) Applicant: MERLN, LLC, Irving, TX (US)

(72) Inventors: Ben Vierck, Ballwin, MO (US); Jeremy Slater, Friendswood, TX (US); Justin Hofer, O'Fallon, MO (US)

(21) Appl. No.: 18/274,174

(22) PCT Filed: Jan. 19, 2022
(86) PCT No.: PCT/US2022/012971

§ 371 Date: Jul. 25, 2023

Related U.S. Application Data
(60) Provisional application No. 63/142,218, filed on Jan. 27, 2021.

(51) Int. Cl. G06N 3/08; G06N 3/045

(52) U.S. Cl. CPC G06N 3/08; G06N 3/045

(57) ABSTRACT

This disclosure enables various computing technologies for preserving signals for artificial neural networks when downsampling. These data science techniques can address various technological concerns and can be helpful for dealing with time series or non-fixed-length time spans or other forms of discretized, parsed, or tokenized data. Some of the data science techniques can enable a process that is technologically beneficial to a user dealing with temporal data sequences that contain multiple event types with differing frequencies. Some of the data science techniques can enable a speed improvement in terms of training an ANN or an accuracy improvement in terms of training an ANN. Some of the data science techniques can enable a technique that implements a series of pooling operations, including learnable pools, to preserve event presence after downsampling.

### CROSS-REFERENCE TO RELATED PATENT APPLICATION

This patent application claims a benefit of priority to U.S. Provisional Patent Application 63/142,218 filed 27 Jan. 2021; which is incorporated by reference herein for all purposes.

### TECHNICAL FIELD

This disclosure relates to various data science techniques for preserving signals for artificial neural networks when downsampling.

### BACKGROUND

A recurrent neural network (RNN) is a type of an artificial neural network (ANN). The RNN (e.g., a stateful RNN) has a plurality of nodes and a plurality of logical connections between the nodes such that the logical connections form a directed graph along a temporal sequence in order to exhibit a temporal dynamic behavior. This configuration allows each of the nodes to have an internal state (e.g., a memory) that can be used to process various sequences of inputs. When training the RNN, various conventional data science techniques can be used for learning from sparse signals in sequential data. However, these techniques are technologically deficient in their abilities to preserve signals for the RNN when used in conjunction with downsampling.

In particular, a signal can refer to a discernible feature in a data sample, where the discernible feature indicates that the data sample belongs to a particular class. For example, if programming a neural net classifier to discriminate between various videos that contain cats and those that do not, then a frame of a video that depicts a feature of a part of a cat can be said to contain a signal within the frame. Correspondingly, a frame of the video that does not depict any features of any parts of the cat can be said not to contain the signal.

An ANN can process a temporal, tokenized, or discretized signal. This can occur in various ways. For example, some cell structures for processing of temporal, tokenized, or discretized information used by various ANNs include a Recurrent Neuron and a Convolutional Neuron. Each of the Recurrent Neuron and the Convolutional Neuron work by starting at a beginning of the temporal, tokenized, or discretized signal and then sequentially processing the temporal, tokenized, or discretized signal until its end. Where the Recurrent Neuron and the Convolutional Neuron differ is in field of view and memory. For example, generally, the Convolutional Neuron is rarely referred to in data science on its own. Rather, the Convolutional Neuron is often referred to as a whole convolutional task, where each of the Convolutional Neurons has a limited (receptive) field of view and overlaps with other Convolutional Neurons via a filter. In contrast, the Recurrent Neuron, being of another neuron type, has various recurrent connections, effectively creating memory.

The Recurrent Neuron processes one unit of a data sequence (e.g., a text sentence with a set of words, a set of voltage readings over a time period, a set of prices over a time period, a set of frames within a video) at a time. Typically, a unit of measure for the data sequence is time (but other forms of tokenized or discretized data are possible). For example, in a 1 second sample of 19 channel 200 Hertz (Hz) Electroencephalography (EEG) data there will be 200 individual units of time, with 19 measured values for each of those units of time. As such, an RNN will process all the measured values for all 19 channels for a first unit of time (1/200 of 1 second sample), and then all the measured values for all 19 channels for a second unit of time (2/200 of 1 second sample), and so on until the RNN processes all 200 units of time (entire 1 second sample). Also, the Recurrent Neuron maintains memory. This memory is an internal value, or state, inside of the Recurrent Neuron that gets updated each time the Recurrent Neuron processes a unit of time. This internal state is preserved throughout the data sequence, although the internal state is constantly being adjusted as new data comes in.

The Recurrent Neuron can be implemented in many ways. One of such ways is shown in FIG. 1, where this implementation passes a previous output of the Recurrent Neuron as a new input for a next time sequence. In this implementation, a Recurrent Layer A outputs a value h at a sequence index t for each input x and an input/output loop allows for information to be passed from one step of the RNN to another step of the RNN. Since the RNN can be thought of as multiple copies of the same ANN, each passing a message to a successor, as shown in FIG. 2, this input/output loop has been unrolled.

As shown in FIGS. 3-15, there is an example where there are measured values (blue cells within grid) for 6 moments in time from 5 channels of input labeled A, B, C, D, and E. Note that these are illustrative and can vary, whether lesser or greater. Regardless, each of these input channels, A through E, has an associated weight W (green cells within grid) for a neuron set or selected by a user (e.g., a data scientist). For example, at least some weights can be initialized to random values within a given range. Also, there is an associated weight W (last row of grid) for a Recurrent State that is passed in from a previous output. In this case, this weight is −1. Note that the Recurrent State has a value that is initialized at 0, but this will be set to be equal to a previous run's output as the RNN does its work.

To illustrate how memory works in an RNN, as shown in FIGS. 4-6, there is a computation of the Recurrent State for each unit in time. As shown in FIG. 4, for a first time step, Channel A has a value of 7, Channel B has a value of 3, Chanel C has a value of 1, Channel D has a value of 9, and Channel E has a value of 1. The Recurrent State starts initialized at 0. Therefore, there is a calculation for an output of the Recurrent State, which is a sum of each channel value multiplied by its associated weight plus a value of the Recurrent State multiplied by its associated weight. This calculation is expressed as (A₀*A_{w}+B₀*B_{w}+C₀*C_{w}+D₀*D_{w}+E₀*E_{w}+R₀*R_{w}). Therefore, for a Time Step 1, the output of the Recurrent State output for this neuron will be 4, which is calculated as: (7*1+3*2+1*(−2)+9*(−1)+1*2+(−1)*0)=4. Similarly, for Time Step 2, there is a summing of each of the values of the Channels A, B, C, D, and E multiplied by its associated weight along with a new value of the Recurrent State multiplied by its associated weight, which is calculated as: (3×1+1×2+2×(−2)+8×(−1)+8×2+4×(−1))=5. This process is repeated for all of the values being input until this data sequence has been exhausted and there is a final output, as shown in FIG. 5. In these examples, note that the Recurrent State for any time step is from an output from a previous time step and a set of weights, in number and value, does not change.

Unlike the Recurrent Neuron that processes data, a single moment at a time, the Convolutional Neuron processes data, multiple moments in time, at a time. How many of multiple moments in time the Convolution Neuron simultaneously processes is an adjustable meta-parameter. For example, the Convolution Neuron can simultaneously process 2 moments, 4 moments, 10 moments, or more. Again, using 1 second of 19 channel 200 Hz EEG, but this time supposing that there are 5 moments of time to be simultaneously processed by the Convolutional Neuron. First, the Convolutional Neuron will process the 1st, 2nd, 3rd, 4th, and 5th signals for all 19 channels of EEG. Then, the Convolutional Neuron will process the 2nd, 3rd, 4th, 5th, and 6th signals. This will happen for all signals in the data sequence until the Convolutional Neuron finally processes the 196th, 197th, 198th, 199th, and 200th signals for all 19 channels. Using identical values for channels as shown in FIG. 5, there is a table shown in FIG. 6. Also, there is a weight kernel with a shape of two, meaning that for each channel, the weight kernel will have two values which are applied during a convolution process. As shown in FIG. 7, by convention, a set of values in a set of kernel weights is initialized to a set of random numbers. Therefore, because the weight kernel has the shape of two, the weight kernel will process two units of the data sequence at a time. As such, in its first iteration, the convolution process generates an output that is calculated, as shown in FIG. 8. Plugging in the values for the first time sequence in this example is shown in FIGS. 9-10. Then, the convolution process takes a stride in a right direction and processes its second iteration. How long the stride is, in this example, one, is set or selected by the user and identical values of the weight kernel are applied. Resultantly, in its second iteration, the convolution process generates an output that is calculated, as shown in FIG. 11. In this example, plugging in the values for the first time sequence is shown in FIGS. 12-13. The convolution process continues, as shown in FIG. 14, until the first time sequence is exhausted. This results in a final output from the convolution process, as shown in FIG. 15.

What the Recurrent Neuron and the Convolutional Neuron have in common is that each is suited for use with very high frequency signals relative to a sampling rate of a recording (e.g., an EEG recording). If a singular event's component sub-signals are very close together in the recording, then each of the Recurrent Neuron and the Convolutional Neuron can identify these sub-signals. For example, assuming a signal of FIG. 16 as input, there is a desire to identify a location of a drastic spike in amplitude (e.g., X-axis is units of time and Y-axis is signal value). As such, each of the Recurrent Neuron and the Convolutional Neuron to identify the drastic spike in question. For the Convolutional Neuron, an identification of a simple weight kernel can show where the drastic spike is located. For example, a weight kernel with weights [−1,1] can be used and applied to a signal, as shown in FIG. 17 (e.g., X-axis is units of time and Y-axis is kernel output value). As is plainly visible in FIG. 17, there is a significant positive signal at an occurrence of the drastic spike and significant negative signals preceding and following the drastic spike. For the Recurrent Neuron, a weight of 1 can be applied to an input thereof and a weight of −1 to a recurrent state thereof, as shown in FIG. 18 (e.g., X-axis is units of time and Y-axis recurrent neuron output value). In this case, the Recurrent Neuron has a small oscillating output that gets activated and holds memory of the drastic spike occurring. So originally the Recurrent Neuron is unset, but holds a high amplitude oscillating pattern after the drastic spike occurs. By utilizing a Rectified Linear Unit Activation, a chart of FIG. 19 can be produced similar to the Convolutional Neuron that has a large activation when the drastic spike occurs (e.g., X-axis is units of time and Y-axis is rectified linear unit activation output value). However, when an event's component sub-signals are further apart, then each of the Recurrent Neuron and the Convolutional Neuron have technological difficulties in identifying the sub-signals. For example, consider an event shown in FIG. 20 (e.g., X-axis is units of time and Y-axis is signal value). This event is characterized by a negative signal of −20, 4 time periods of no or minimal activity, a negative signal of −33, 9 time periods of no or minimum activity, a positive signal of 33, 4 time periods of no or minimum activity, and then a positive signal of 20. For a convolutional ANN (e.g., a convolutional neural network (CNN)) to identify this signal, the CNN would need a weight kernel of 21 weights, which is computationally intensive and contrary to best practices of data science. Although an RNN could identify this signal, the RNN would need many neurons doing tasks like counting a number of time steps between various subcomponents.

One way to solve this technological issue is through a usage of a downsampling technique. This technique is an act of collapsing a higher frequency stream into a lower frequency stream. By changing a frequency of a dataset to a lower frequency, there can be a grouping together of those component sub-signals, making those sub-signals easier for a neuron (e.g., the Recurrent Neuron, the Convolutional Neuron) to process. By reducing a length of a signal, this also imparts a performance improvement, as the neuron takes less time to process a shorter sequence than a longer one, as shown in FIG. 21 (e.g., X-axis is units of time and Y-axis is signal output value). Just taking the Convolutional Neuron as an example, as shown in FIG. 22 (e.g., X-axis is units of time and Y-axis is convolutional neuron output value), there is now needed 5 weights in a weight kernel, in this case [−1,−1,0,1,1] and once again, the signal is plainly visible in an output.

When downsampling a sequence for an ANN, a new sampling frequency can be chosen that condenses various component sub-signals of the sequence to be temporally adjacent. However, a technological issue arises if multiple different events relevant to a task have different frequencies (e.g., a multi-signal stream). For example, there may be a data stream that includes three kinds of signals, as shown in FIG. 23 (e.g., X-axis is units of time and Y-axis is signal value). The first, some background noise ambient to an environment in which there is recording data (e.g., an EEG recording may have noise at 60 Hz caused by power-line interference). In addition to the background noise, there are two other sources of signal, each originating from some event that is desired to be detected, as shown in FIG. 24 (e.g., X-axis is units of time and Y-axis is signal value). These components summed is what is shown as raw signal in FIG. 25 (e.g., X-axis is units of time and Y-axis is signal value). When reviewing this raw output, Event 1 is readily distinguishable. However, as explained previously, when an event's component sub-signals are further apart, an ANN has great technological difficulty in detecting the sub-signals. In other words, for a machine, Event 2 is very technologically difficult to distinguish in this raw format. Through downsampling, though, this problem can be eliminated or minimized in order to help the machine to distinguish. For example, if this signal is downsampled by ⅕, then a new signal is formed, as shown in FIG. 26 (e.g., X-axis is units of time and Y-axis is signal value). However, when reviewing this raw output of this new downsampled signal, although Event 2 is readily distinguishable, Event 1 has disappeared entirely. As such, given a dataset where events occur at frequencies which vary widely, various conventional data science downsampling methods are technologically deficient in their ability to preserve the signals for the ANN when downsampling.

### SUMMARY

Broadly, this disclosure enables various computing technologies for preserving signals for artificial neural networks when downsampling (e.g., when used in conjunction with downsampling). These data science techniques can address various technological concerns, as explained above, and can be helpful for dealing with time series or non-fixed-length time spans or other forms of discretized, parsed, or tokenized data. Some of the data science techniques can enable a process that is technologically beneficial to a user (e.g., a data scientist) dealing with temporal data sequences that contain multiple event types with differing frequencies. Some of the data science techniques can enable a speed improvement in terms of training an ANN (e.g., speed of learning) or an accuracy improvement in terms of training an ANN (e.g., accuracy of prediction). Some of the data science techniques can enable a technique that implements a series of pooling operations, including learnable pools, to preserve event presence after downsampling. For example, as explained above, downsampling, as a technique for enabling an ANN to recognize various sub-signals that occur further apart (at lower frequencies), results in a loss of events that occur at high frequencies. However, this disclosure enables a technique for downsampling which makes those low frequency events evident, without resulting in the loss of events that occur at high frequencies. Therefore, this disclosure enables combining various discrete downsampling techniques for preserving signals for machine learning, which can include Deep Learning.

An embodiment can include a method of preserving signals for artificial neural networks when downsampling, the method comprising: receiving, by a processor, a set of hyperparameters for a model of an artificial neural network (ANN) and a downsample factor for the model, wherein the ANN includes a first layer (e.g., an input layer), a pooling layer, and a second layer (e.g., a subsequent layer), wherein the first layer feeds the pooling layer, wherein the pooling layer feeds the second layer, wherein the pooling layer is positioned between the first layer and the second layer, wherein the pooling layer contains a maximum pool, a minimum pool, an average pool, a learnable pool, and a concatenating function; receiving, by the processor, within the pooling layer, an input set of data from the first layer; forming, by the processor, within the pooling layer, a plurality of copies of the input set of data; inputting, by the processor, within the pooling layer, the copies to each of the maximum pool, the minimum pool, the average pool, and the learnable pool according to the set of hyperparameters based on the downsample factor; receiving, by the processor, within the pooling layer, a pooling output from each of the maximum pool, the minimum pool, the average pool, and the learnable pool; inputting, by the processor, within the pooling layer, the pooling output from each of the maximum pool, the minimum pool, the average pool, and the learnable pool into the concatenating function such that the concatenating function outputs a concatenated output within the pooling layer formed based on the pooling output from each of the maximum pool, the minimum pool, the average pool, and the learnable pool; inputting, by the processor, the concatenated output from the pooling layer into the second layer; and taking, by the processor, an action based on the concatenated output being in the second layer.

An embodiment can include a system of preserving signals for artificial neural networks when downsampling, the system comprising: a server programmed to: receive a set of hyperparameters for a model of an artificial neural network (ANN) and a downsample factor for the model, wherein the ANN includes a first layer (e.g., an input layer), a pooling layer, and a second layer (e.g., a subsequent layer), wherein the first layer feeds the pooling layer, wherein the pooling layer feeds the second layer, wherein the pooling layer is positioned between the first layer and the second layer, wherein the pooling layer contains a maximum pool, a minimum pool, an average pool, a learnable pool, and a concatenating function; receive, within the pooling layer, an input set of data from the first layer; form, within the pooling layer, a plurality of copies of the input set of data; input, within the pooling layer, the copies to each of the maximum pool, the minimum pool, the average pool, and the learnable pool according to the set of hyperparameters based on the downsample factor; receive, within the pooling layer, a pooling output from each of the maximum pool, the minimum pool, the average pool, and the learnable pool; input, within the pooling layer, the pooling output from each of the maximum pool, the minimum pool, the average pool, and the learnable pool into the concatenating function such that the concatenating function outputs a concatenated output within the pooling layer formed based on the pooling output from each of the maximum pool, the minimum pool, the average pool, and the learnable pool; input, the concatenated output from the pooling layer into the second layer; and take, an action based on the concatenated output being in the second layer.

### DESCRIPTION OF DRAWINGS

FIG. 1 to FIG. 26 illustrate various diagrams of various data science techniques according to this disclosure.

FIG. 27 illustrates a diagram of an embodiment of a system for preserving signals for artificial neural networks when downsampling according to this disclosure.

FIG. 28 to FIG. 75 illustrate various embodiments of various computational techniques for preserving signals for artificial neural networks when downsampling according to this disclosure.

### DETAILED DESCRIPTION

Broadly, this disclosure enables various computing technologies for preserving signals for artificial neural networks when downsampling (e.g., when used in conjunction with downsampling). These data science techniques can address various technological concerns, as explained above, and can be helpful for dealing with time series or non-fixed-length time spans or other forms of discretized, parsed, or tokenized data. Some of the data science techniques can enable a process that is technologically beneficial to a user (e.g., a data scientist) dealing with temporal data sequences that contain multiple event types with differing frequencies. Some of the data science techniques can enable a speed improvement in terms of training an ANN (e.g., speed of learning) or an accuracy improvement in terms of training an ANN (e.g., accuracy of prediction). Some of the data science techniques can enable a technique that implements a series of pooling operations, including learnable pools, to preserve event presence after downsampling. For example, as explained above, downsampling, as a technique for enabling an ANN to recognize various sub-signals that occur further apart (at lower frequencies), results in a loss of events that occur at high frequencies. However, this disclosure enables a technique for downsampling which makes those low frequency events evident, without resulting in the loss of events that occur at high frequencies. Therefore, this disclosure enables combining various discrete downsampling techniques for preserving signals for machine learning, which can include Deep Learning.

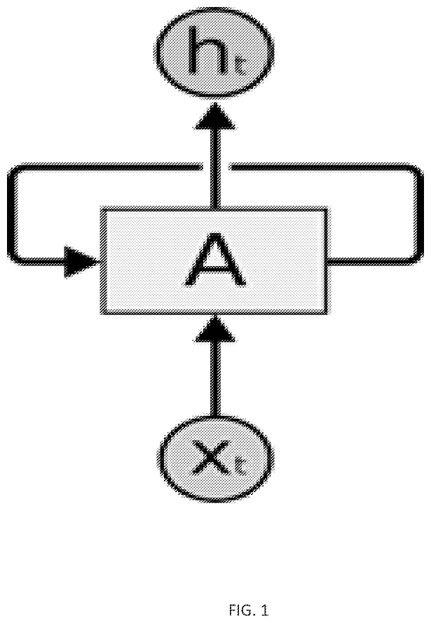

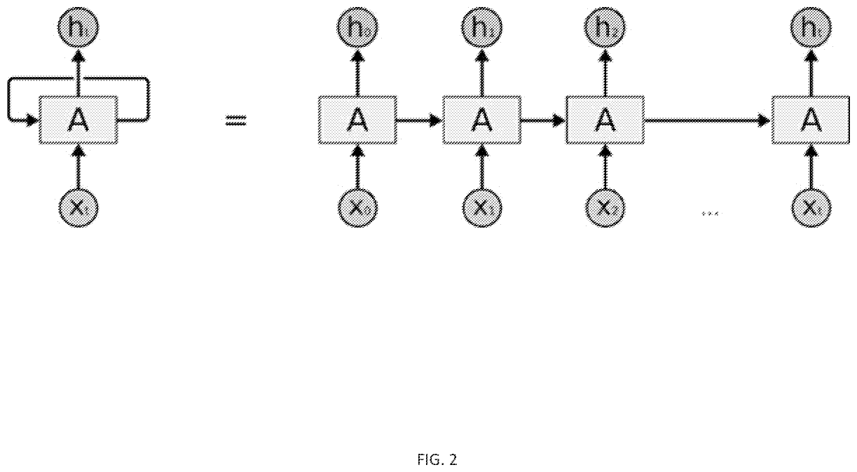

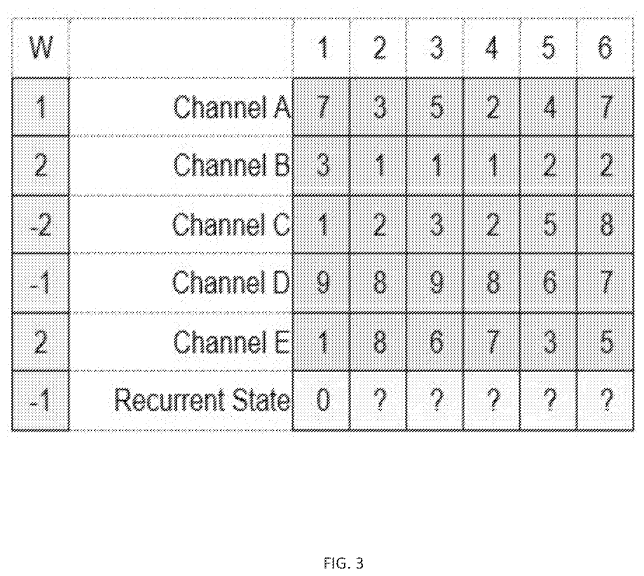

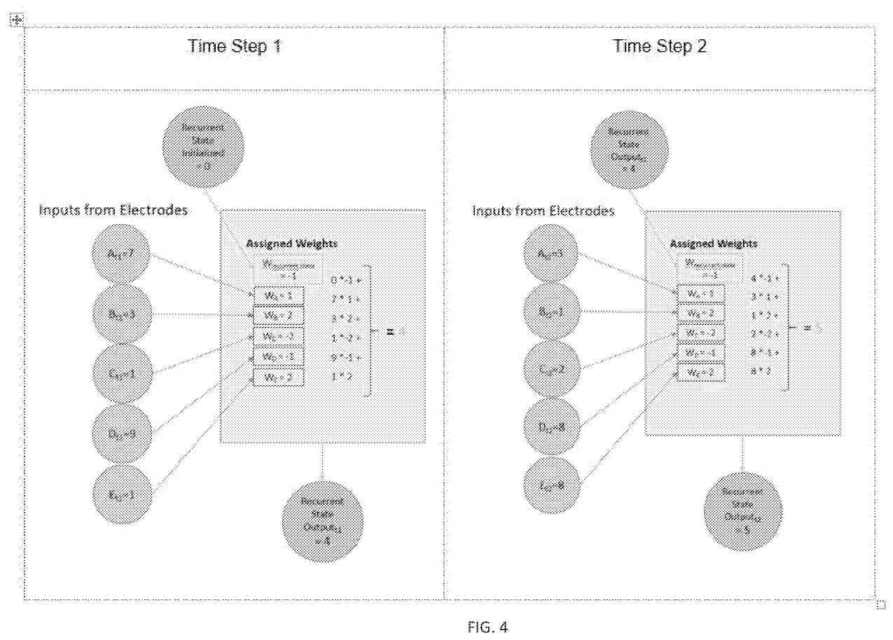

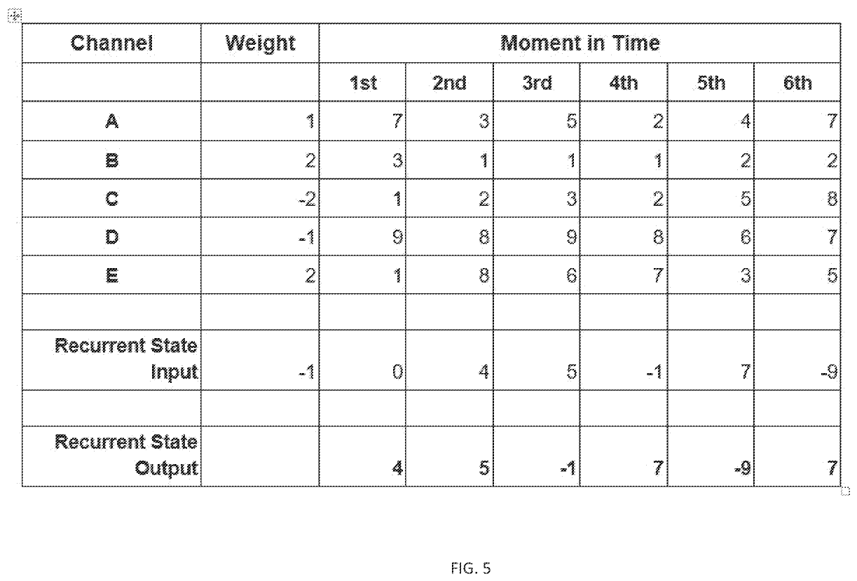

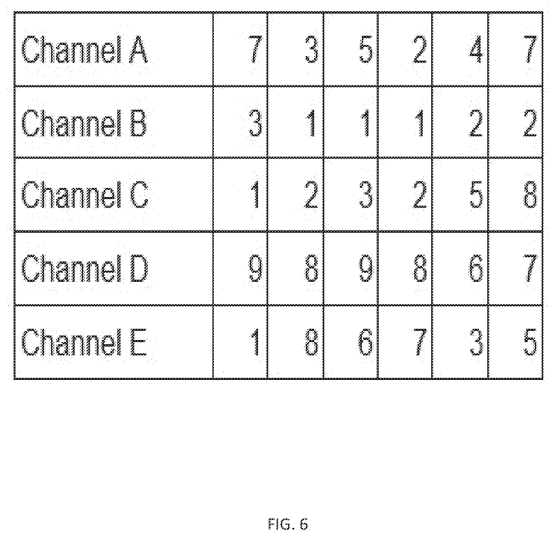

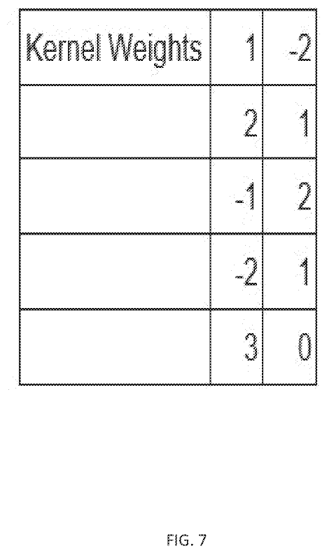

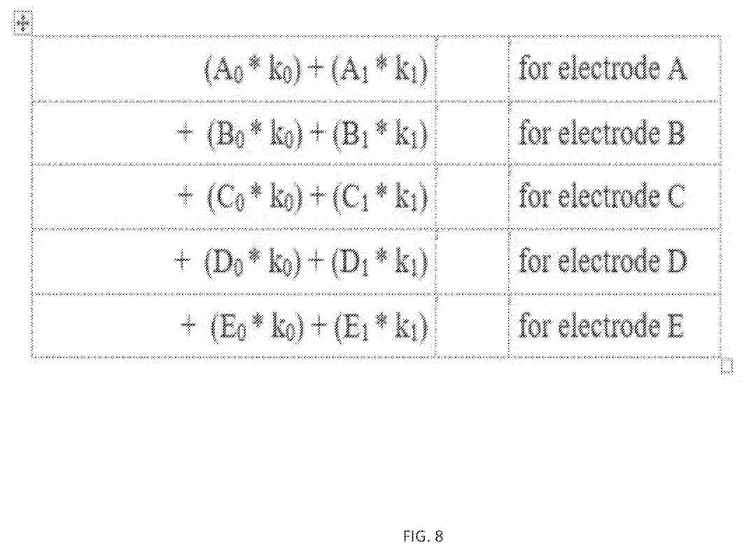

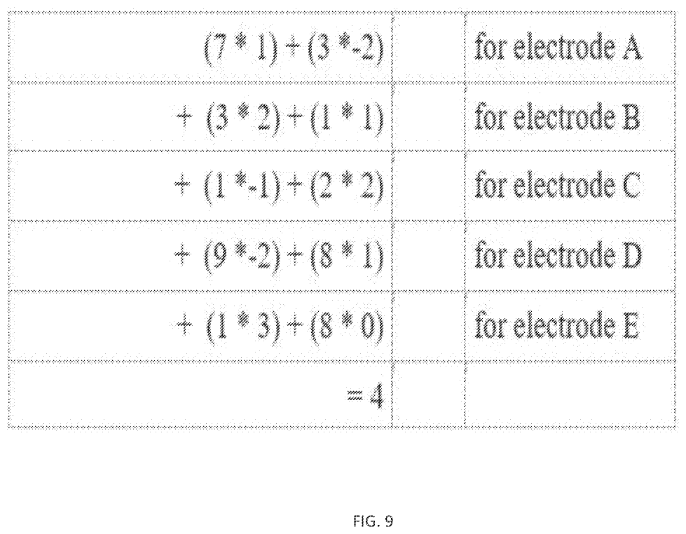

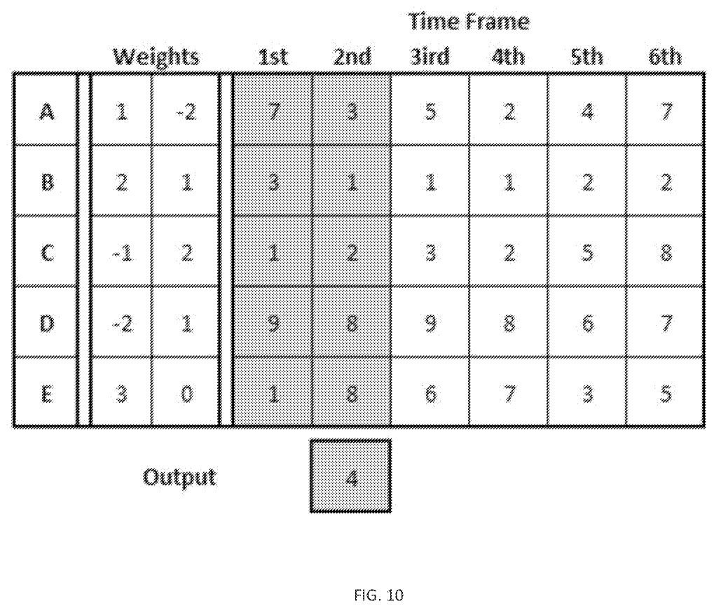

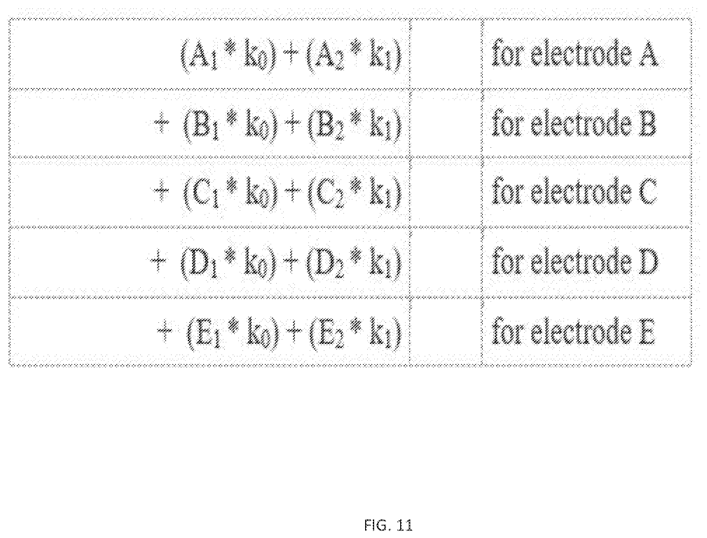

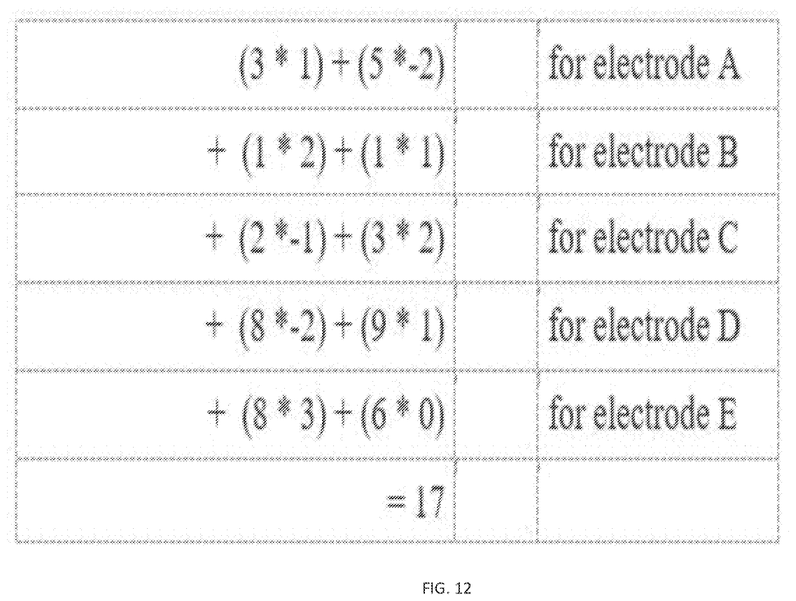

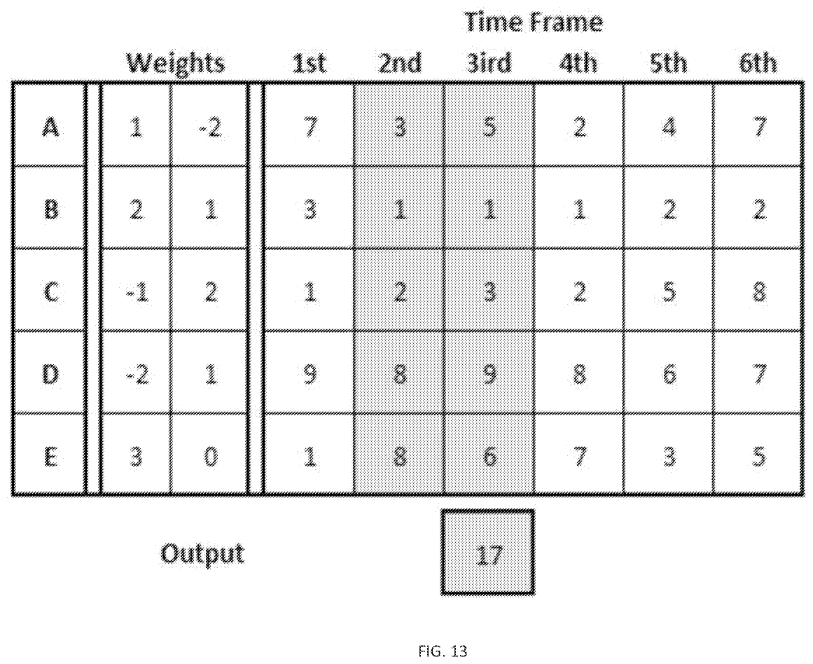

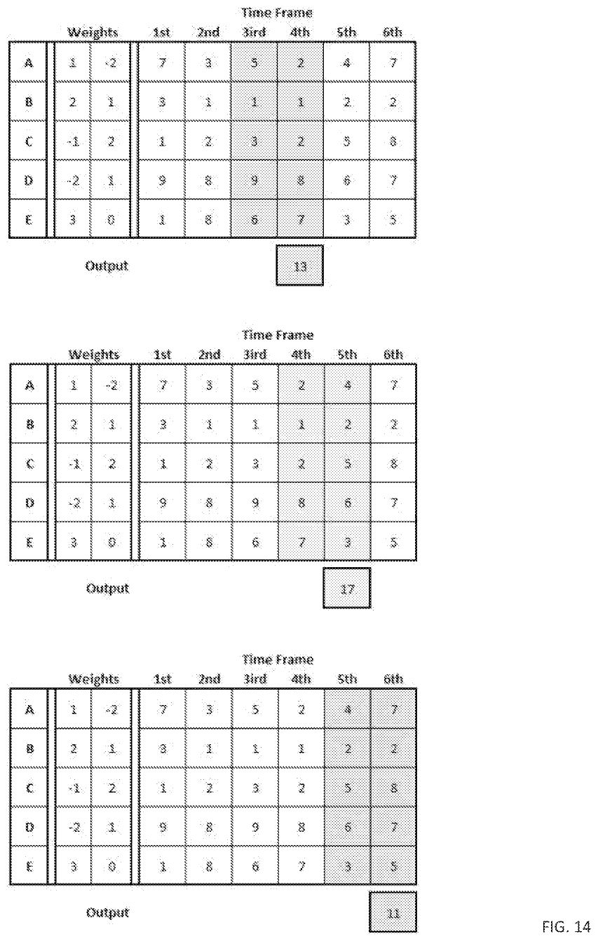

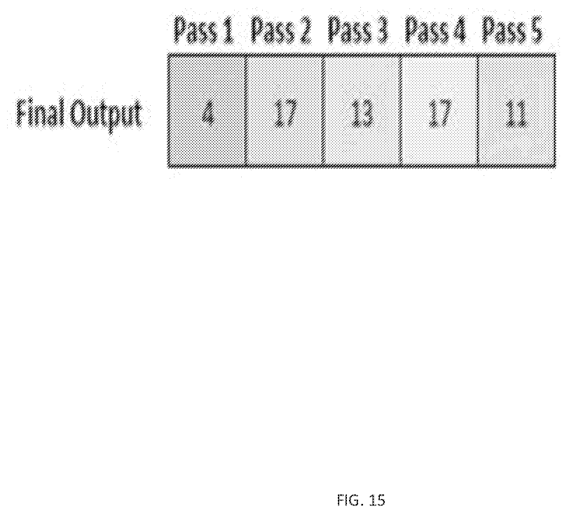

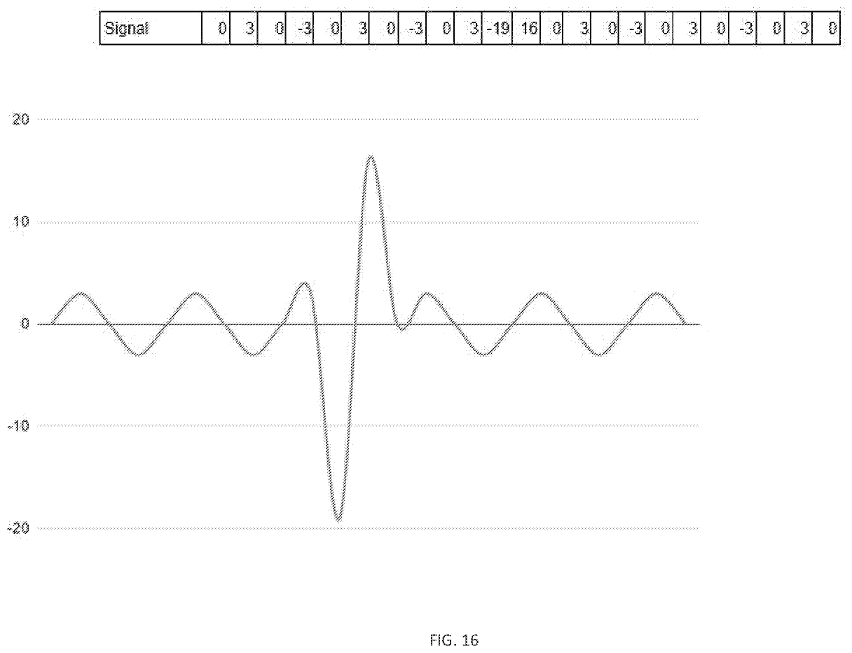

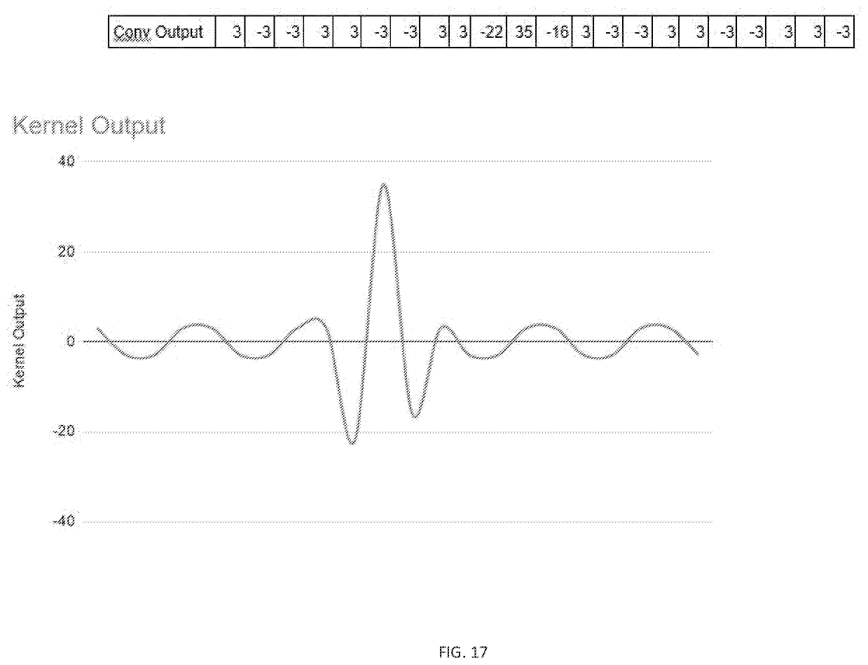

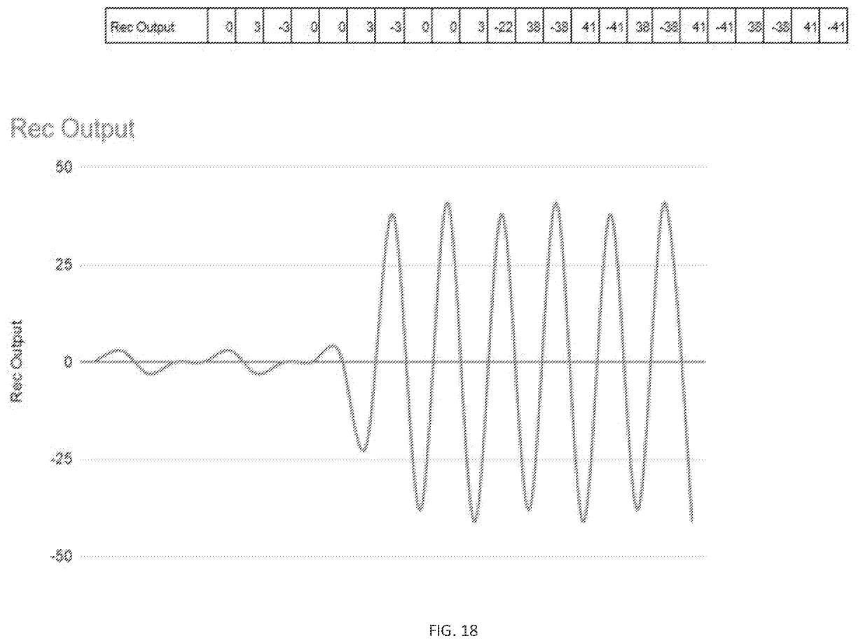

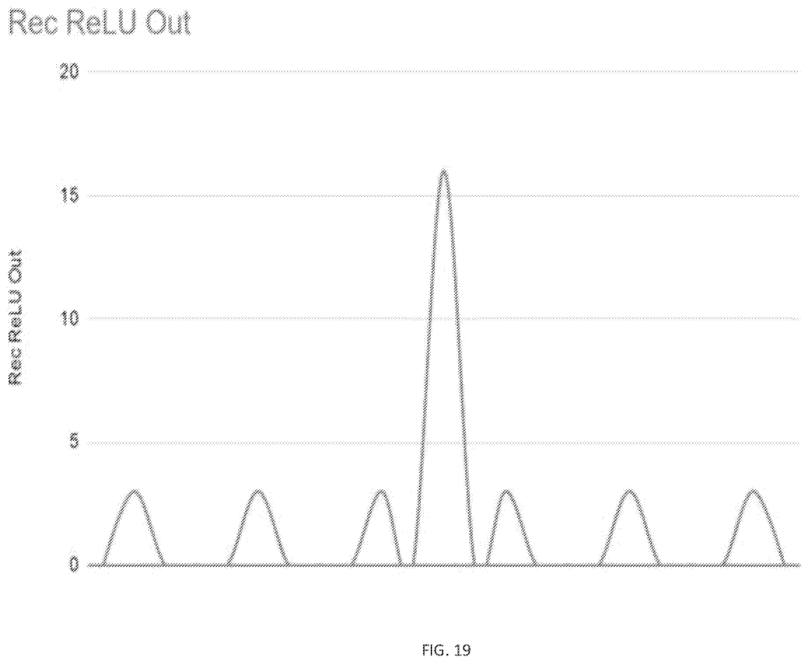

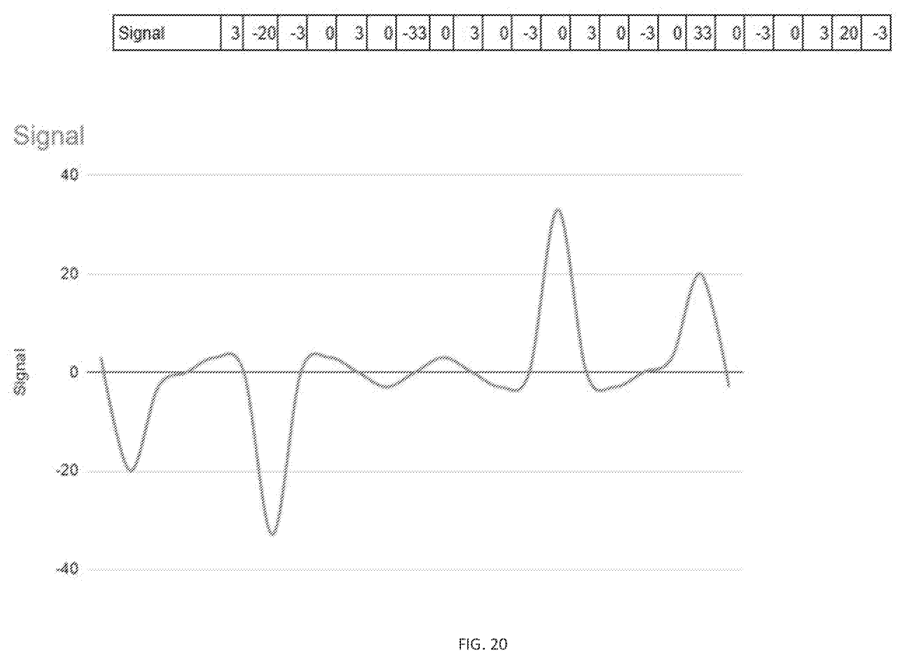

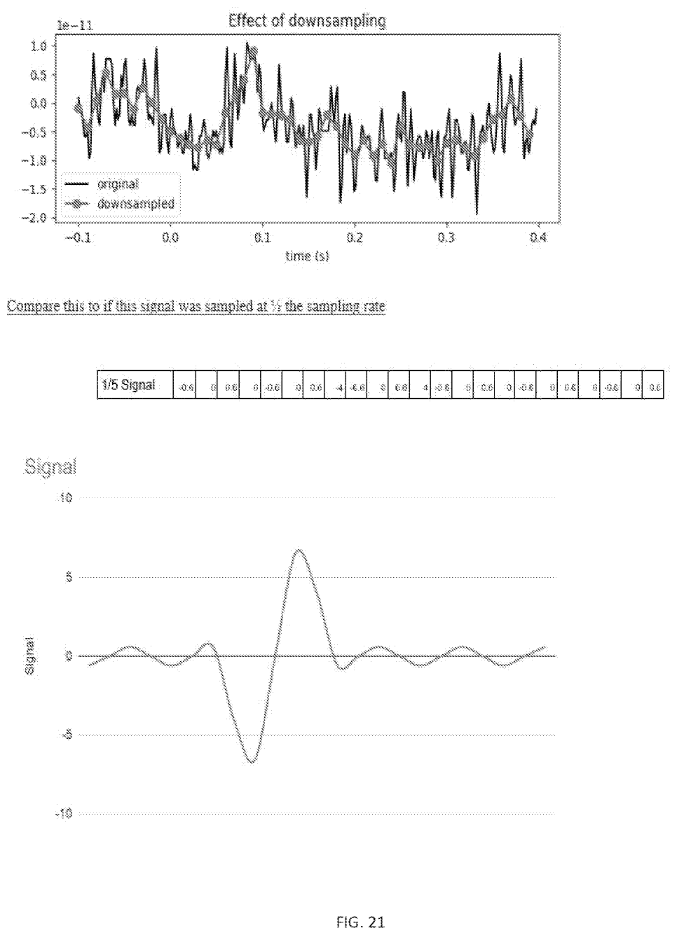

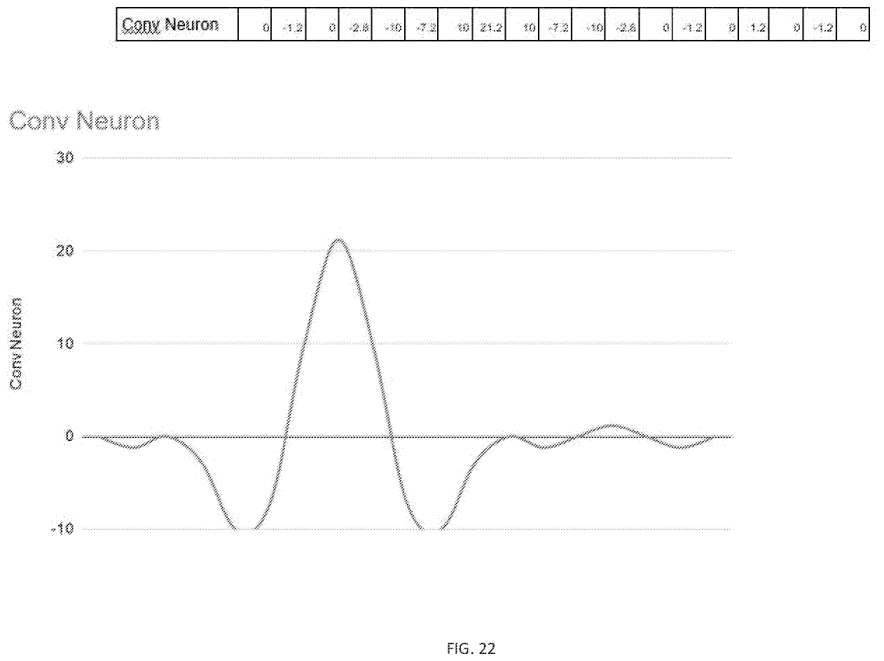

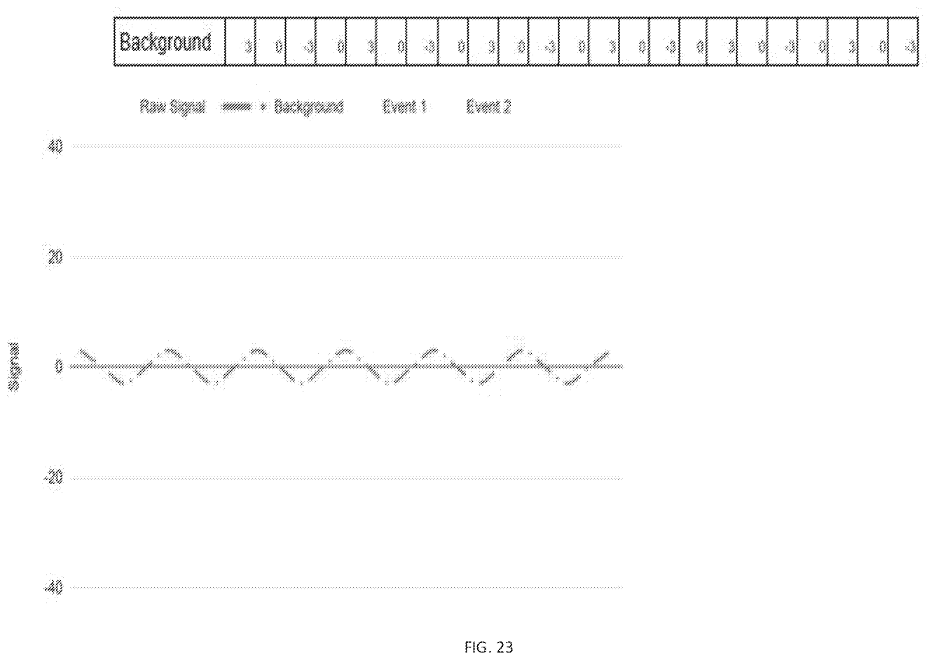

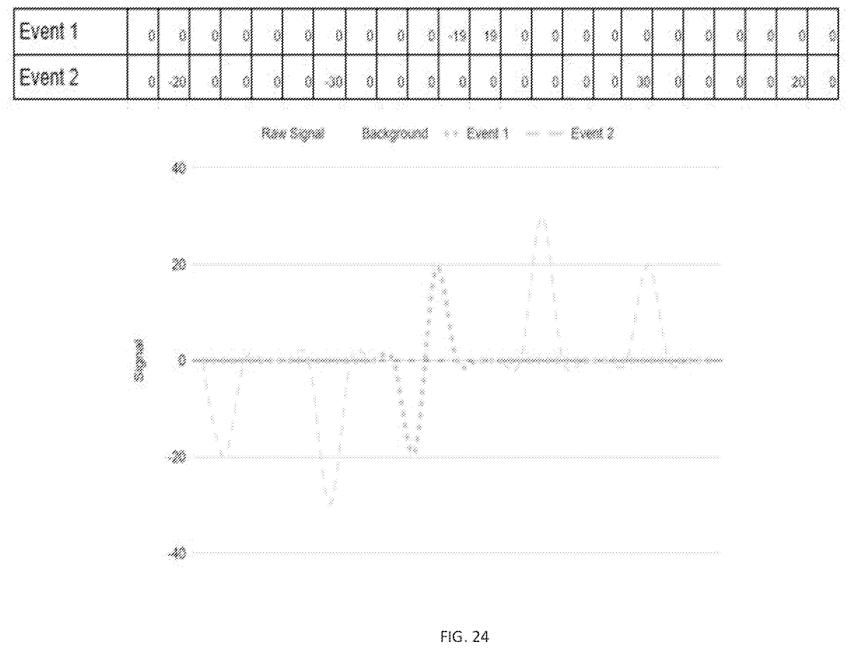

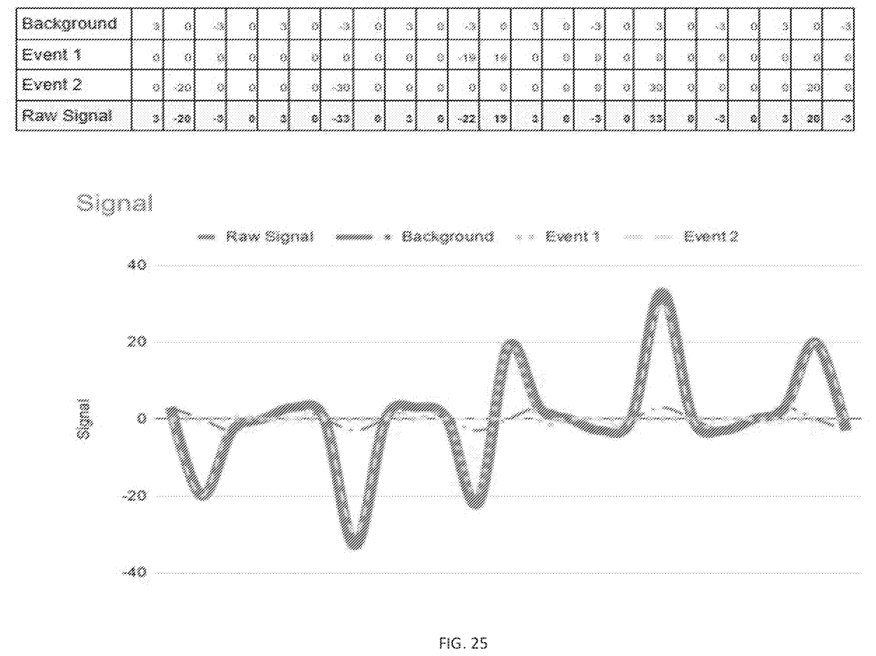

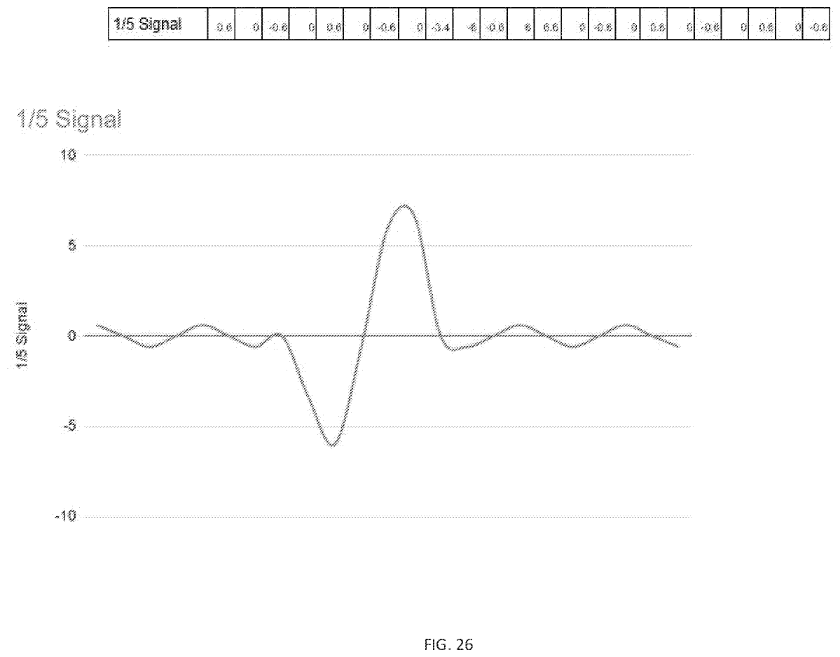

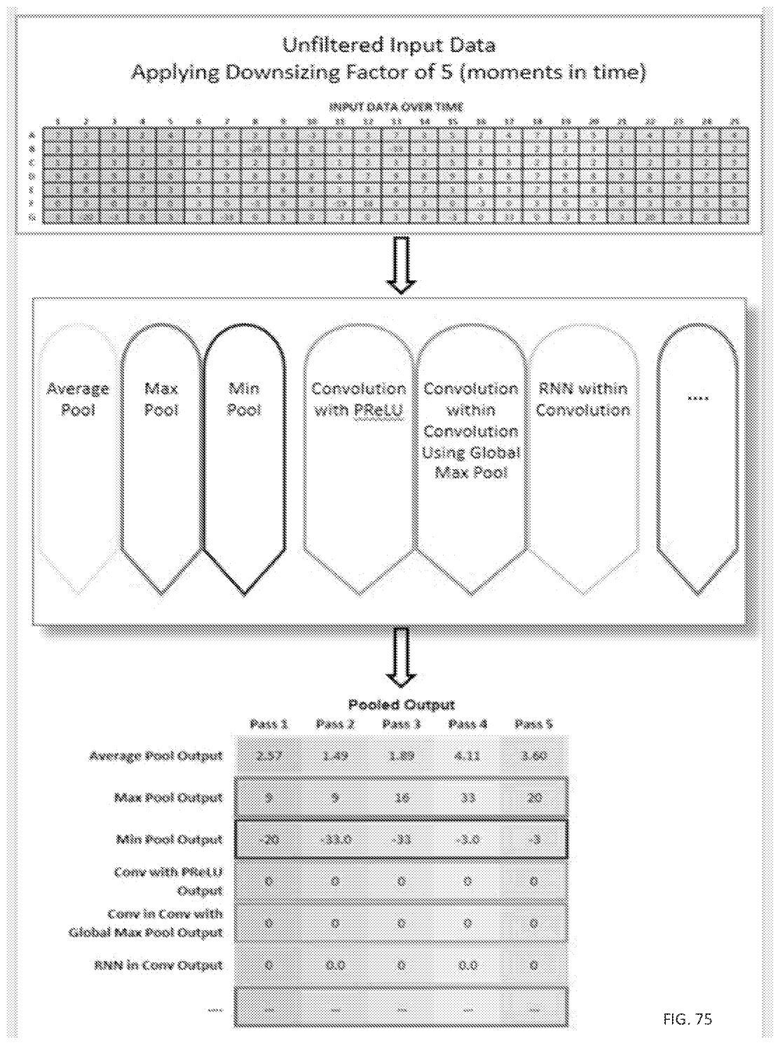

This disclosure is now described more fully with reference to FIGS. 1-75, in which various embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms as well, unless context clearly indicates otherwise. For example, a term “a” or “an” shall mean “one or more,” even though a phrase “one or more” is also used herein. For example, “a” or “an” or “one or more” includes one, two, three, four, five, six, seven, eight, nine, ten, tens, hundreds, thousands, or more including all intermediary whole or decimal values therebetween.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Hereby, all issued patents, published patent applications, and non-patent publications (including hyperlinked articles, web pages, and websites) that are mentioned in this disclosure are herein incorporated by reference in their entirety for all purposes, to same extent as if each individual issued patent, published patent application, or non-patent publication were copied and pasted herein or specifically and individually indicated to be incorporated by reference. If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

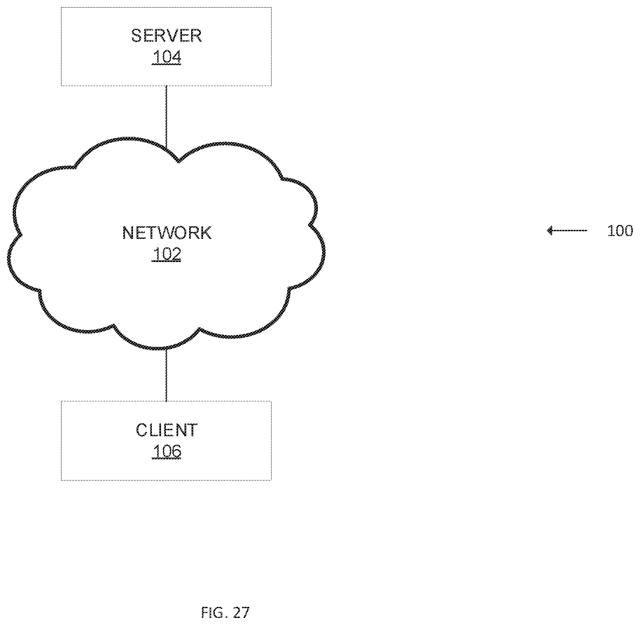

FIG. 27 is a diagram of an embodiment of a system for preserving signals for artificial neural networks when downsampling according to this disclosure. In particular, a system 100 includes a network 102, a server 104, and a client 106. The server 104 and the client 106 are in communication (e.g., wired, wireless, waveguide) with each other over the network 102.

The network 102 includes a plurality of computing nodes interconnected via a plurality of communication channels, which allow for sharing of resources, applications, services, files, streams, records, information, or others. The network 102 can operate via a network protocol, such as an Ethernet protocol, a Transmission Control Protocol (TCP)/Internet Protocol (IP), or others. The network 102 can have any scale, such as a personal area network (PAN), a local area network (LAN), a home area network, a storage area network (SAN), a campus area network, a backbone network, a metropolitan area network, a wide area network (WAN), an enterprise private network, a virtual private network (VPN), a virtual network, a satellite network, a computer cloud network, an internetwork, a cellular network, or others. The network 102 can include an intranet, an extranet, or others. The network 102 can include Internet. The network 102 can include other networks or allow for communication with other networks, whether sub-networks or distinct networks.

The server 104 can include a web server, an application server, a database server, a virtual server, a physical server, or others. For example, the server 104 can be included within a computing platform (e.g., Amazon Web Services, Microsoft Azure, Google Cloud, IBM cloud) having a cloud computing environment defined via a plurality of servers including the server 104, where the servers operate in concert, such as via a cluster of servers, a grid of servers, a group of servers, or others, to perform a computing task, such as reading data, writing data, deleting data, collecting data, sorting data, or others. For example, the server 104 or the servers including the server 104 can be configured for parallel processing (e.g., multicore processors, multithreading). The computing platform can include a mainframe, a supercomputer, or others. The servers can be housed in a data center, a server farm or others. The computing platform can provide a plurality of computing services on-demand, such as an infrastructure as a service (IaaS), a platform as a service (PaaS), a packaged software as a service (SaaS), or others. For example, the computing platform can providing computing services from a plurality of data centers spread across a plurality of availability zones (AZs) in various global regions, where an AZ is a location that contains a plurality of data centers, while a region is a collection of AZs in a geographic proximity connected by a low-latency network link. For example, the computing platform can enable a launch of a plurality of virtual machines (VMs) and replicate data in different AZs to achieve a highly reliable infrastructure that is resistant to failures of individual servers or an entire data center.

The client 106 includes a logic that is in communication with the server 104 over the network 102. When the logic is hardware-based, then the client 106 can include a desktop, a laptop, a tablet, or others. For example, when the logic is hardware-based, then the client can include an input device, such as a cursor device, a hardware or virtual keyboard, or others. Likewise, when the logic is hardware-based, then the client 106 can include an output device, such as a display, a speaker, or others. Note that the input device and the output device can be embodied in one unit (e.g., touchscreen). When the logic is software-based, then the client 106 can include a software application, a browser, a software module, an executable or data file, a mobile app, or others. Regardless of how the logic is implemented, the logic enables the client 106 to communicate with the server 104, such as to request or to receive a resource/service from the computing platform via a common framework, such as a hypertext transfer protocol (HTTP), a HTTP secure (HTTPS) protocol, a file transfer protocol (FTP), or others.

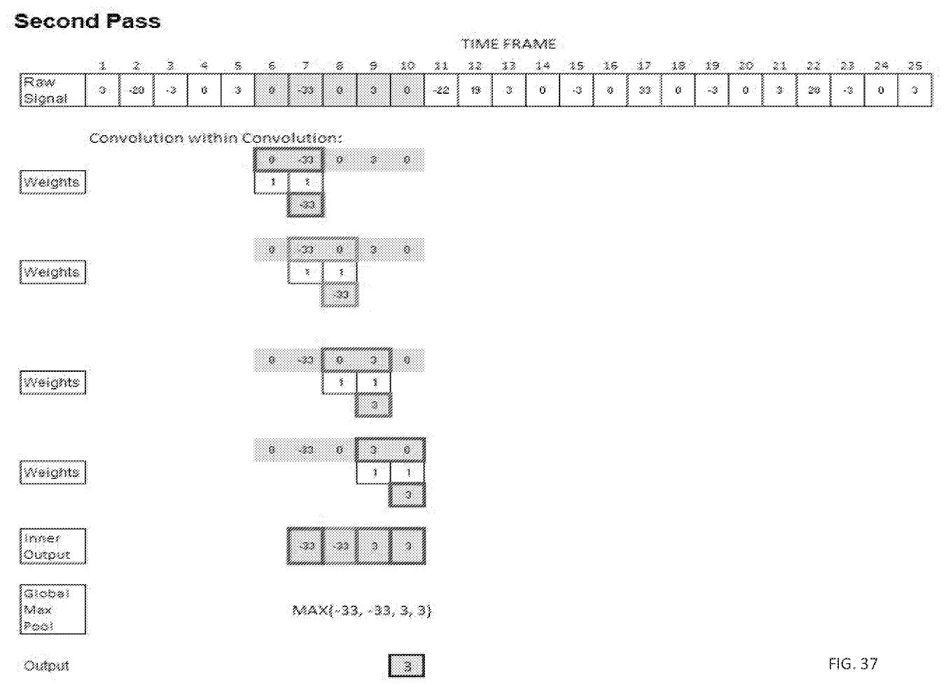

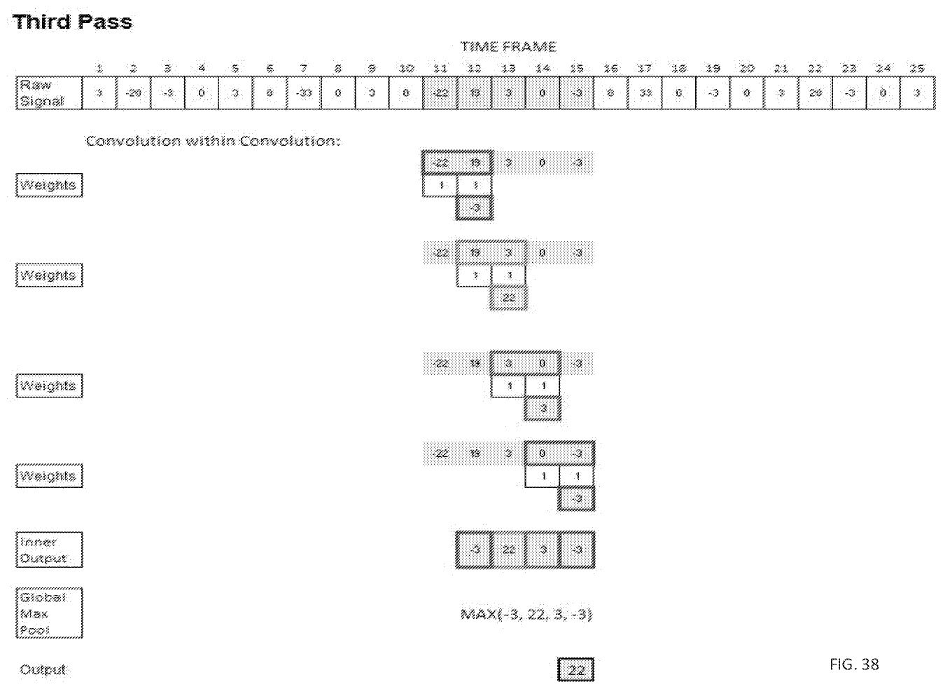

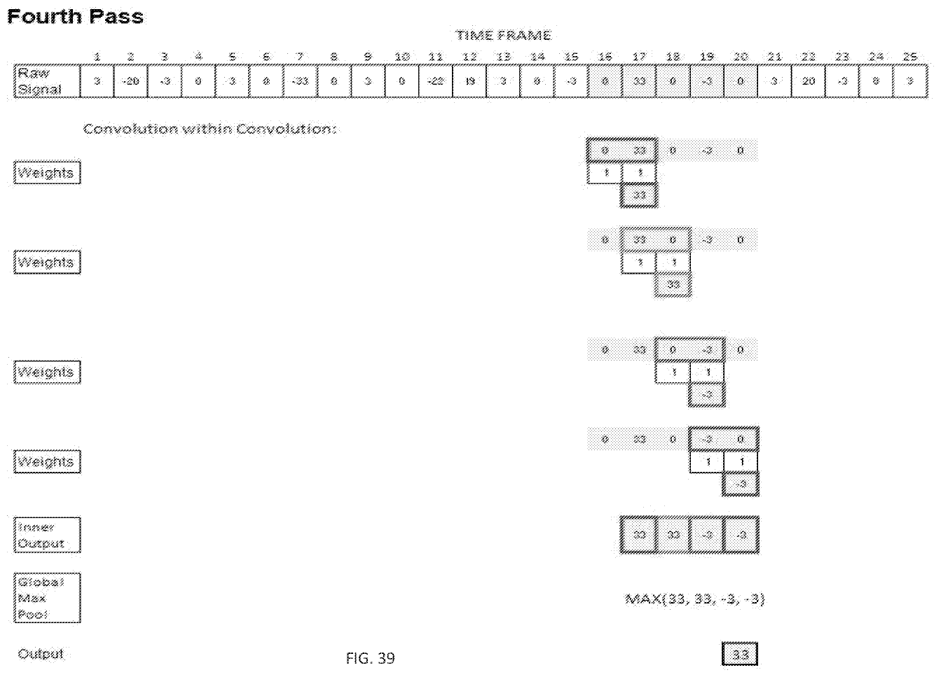

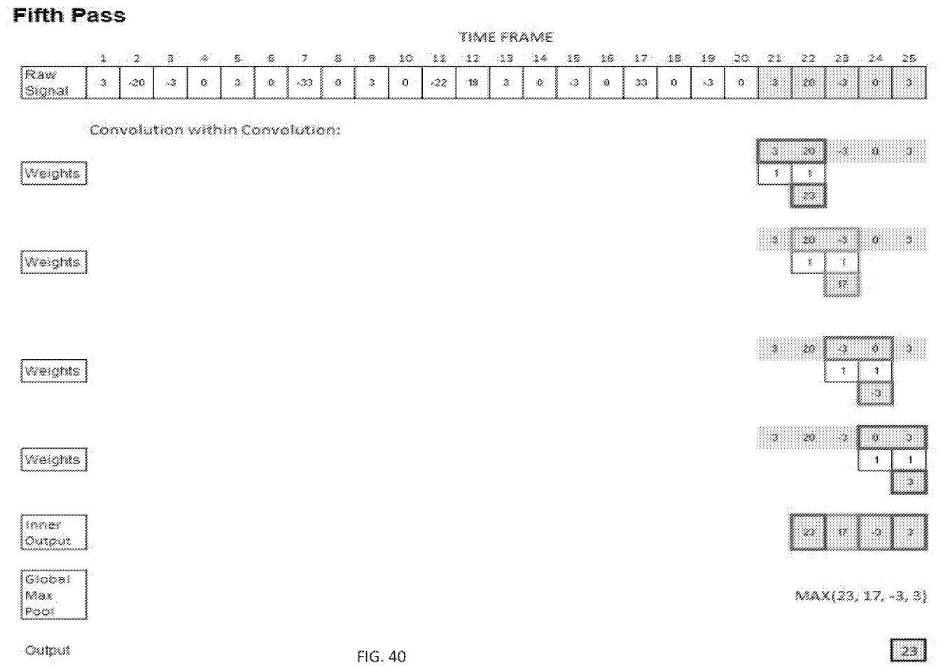

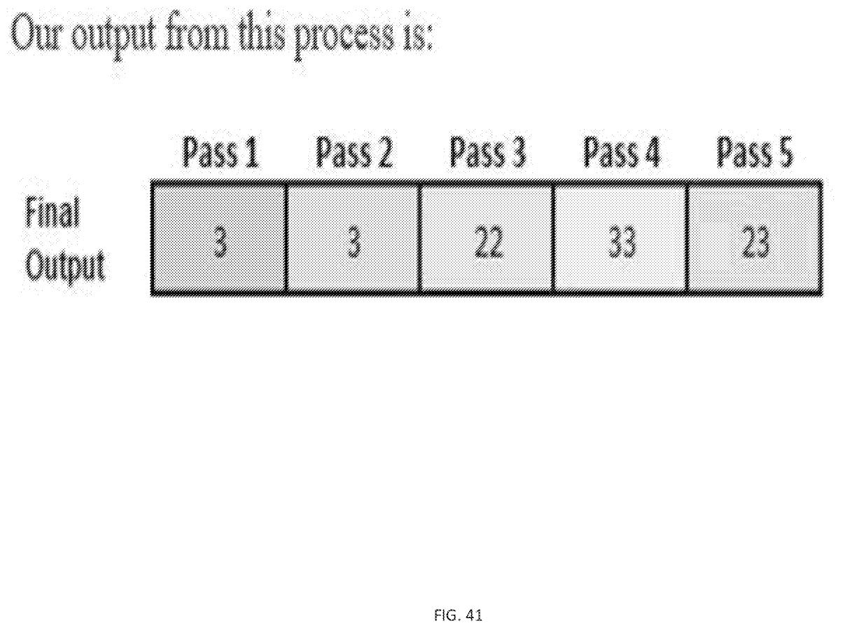

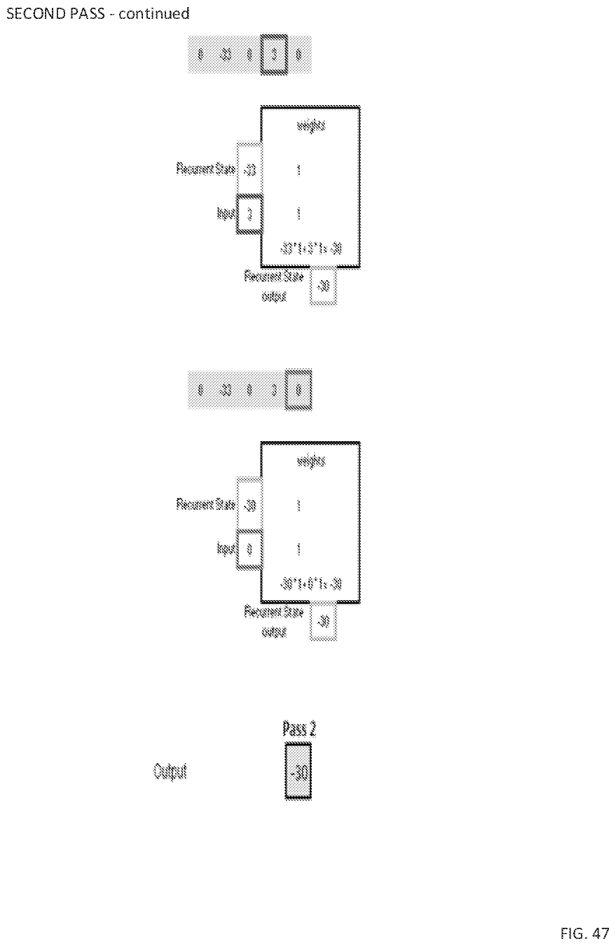

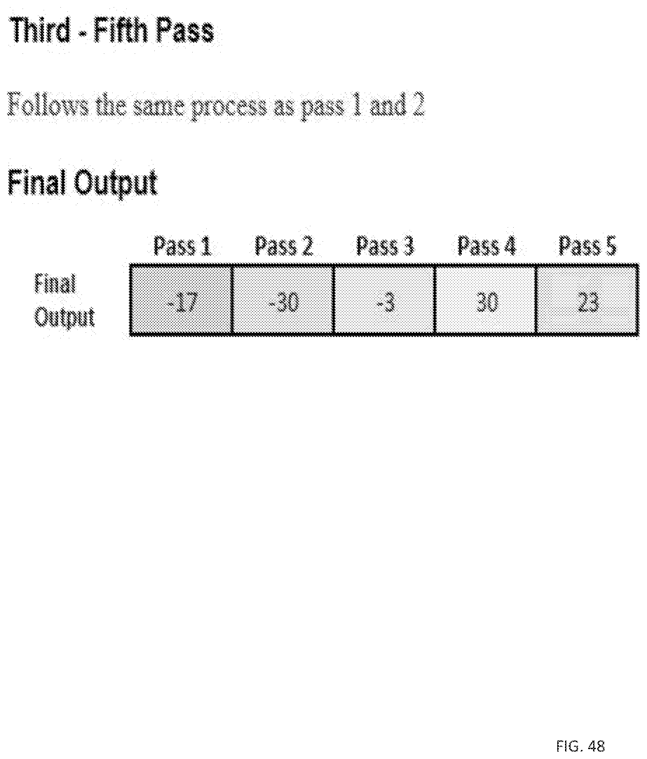

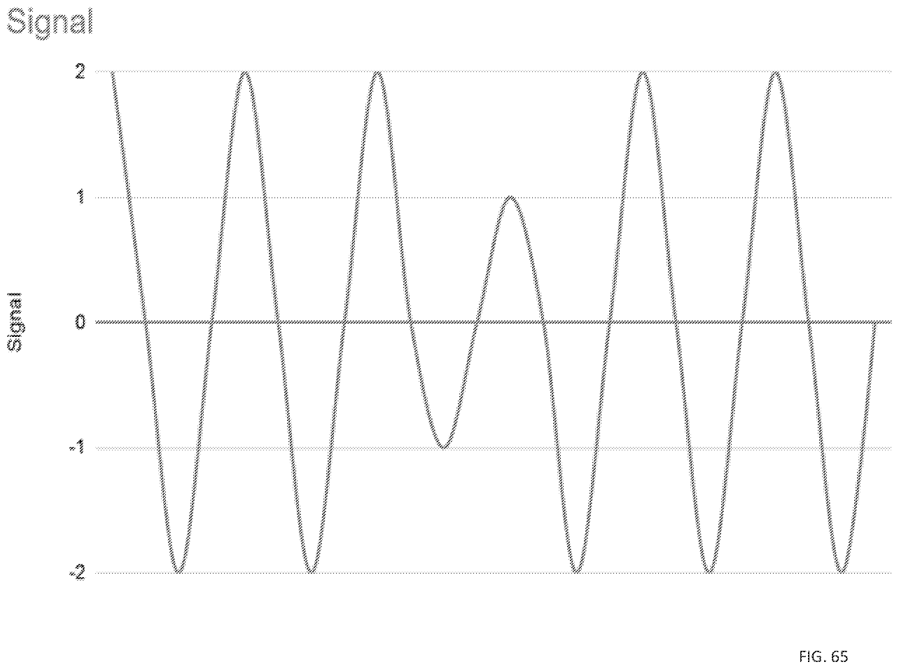

FIGS. 27-75 illustrate various embodiments of various computational techniques for preserving signals for artificial neural networks when downsampling according to this disclosure. In particular, these data science techniques are performed by the server 104 as being requested or instructed over the network 102 by a user (e.g., a data scientist) operating the client 106. The data science techniques can address various technological concerns, as explained above, and can be helpful for dealing with time series or non-fixed-length time spans or other forms of discretized, parsed, or tokenized data. Some of the data science techniques can enable a process that is technologically beneficial to a user (e.g., a data scientist) dealing with temporal data sequences that contain multiple event types with differing frequencies. Some of the data science techniques can enable a speed improvement in terms of training an ANN (e.g., speed of learning) or an accuracy improvement in terms of training an ANN (e.g., accuracy of prediction). Some of the data science techniques can enable a technique that implements a series of pooling operations, including learnable pools, to preserve event presence after downsampling. For example, as explained above, downsampling, as a technique for enabling an ANN to recognize various sub-signals that occur further apart (at lower frequencies), results in a loss of events that occur at high frequencies. However, this disclosure enables a technique for downsampling which makes those low frequency events evident, without resulting in the loss of events that occur at high frequencies.

Pooling includes a method of performing downsampling via usage of tensor operations. For example, a tensor is a data container or repository (e.g., an object, a multidimensional array) that can house data in N dimensions, which can be along with its linear operations. The tensor can include descriptions of various valid linear transformations (or relations) between tensors (e.g., a cross product, a dot product). Resultantly, the pooling includes an act of condensing adjacent values into a single value. How this condensing works is determined by at least three factors: 1) what operation is being performed, 2) what is a size of a pool, and 3) a stride factor.

There are various pooling operations that can be used. Some of these pooling operations include a Max Pool operation, an Average Pool operation, and a Min Pool operation. These refer to a specific operation that will be performed on the adjacent values in order to transform those values into a new smaller set of values. As such, the Max Pool operation computes a maximum value of some set of adjacent values. The Min Pool operation computes a minimum value of some set of adjacent values. The Average Pool operation computes an average of some set of adjacent values.

The size of the pool, or a number of adjacent values that will be condensed down into a single value, is an arbitrary factor set or selected by a user (e.g., a data scientist). For example, a pooling size of 2 would mean that 2 values would be turned into 1 value. Similarly, a pooling size of 10 would mean that 10 values would be turned into 1 value. As such, for a data sequence of 60 values, a pooling size of 2 will transform the data sequence being transformed into 30 values, whereas a pooling size of 10 will transform that same data sequence into just 6 values. Stated differently, if pooling is considered as decreasing a resolution of an image, then if a pooling size is 2, then there is a reduction of an amount of detail in the image by a factor of two. Although this reduction confers a great advantage to the user in terms of compute cost, this also lowers the resolution of the image, which may make the image too blurry to be of value.

The stride factor how many adjacent values will a filter (e.g., a stride) move forward, as a neural network executes its pooling operation, step by step through a set of original data. The stride factor has a default value if not specified by a user (e.g., a data scientist). The default value is the same value as that of the size of the pool.

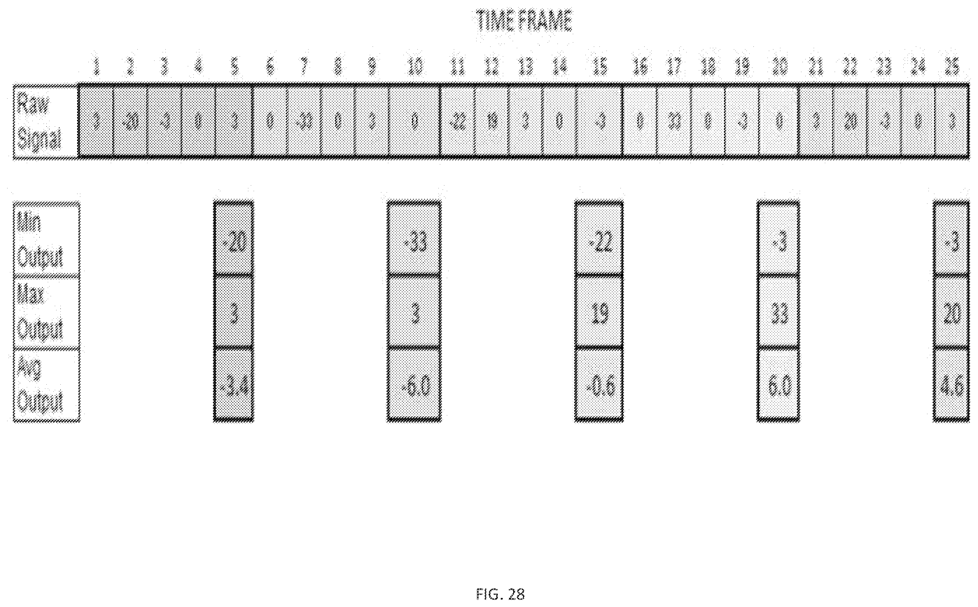

In an example shown in FIG. 28, the server 104 uses a pooling factor of 5 and a stride factor of 5 to pool 25 original data values in a data sequence. Note that colors are used as a visual aid to demonstrate how data is condensed as a result of each pooling operation.

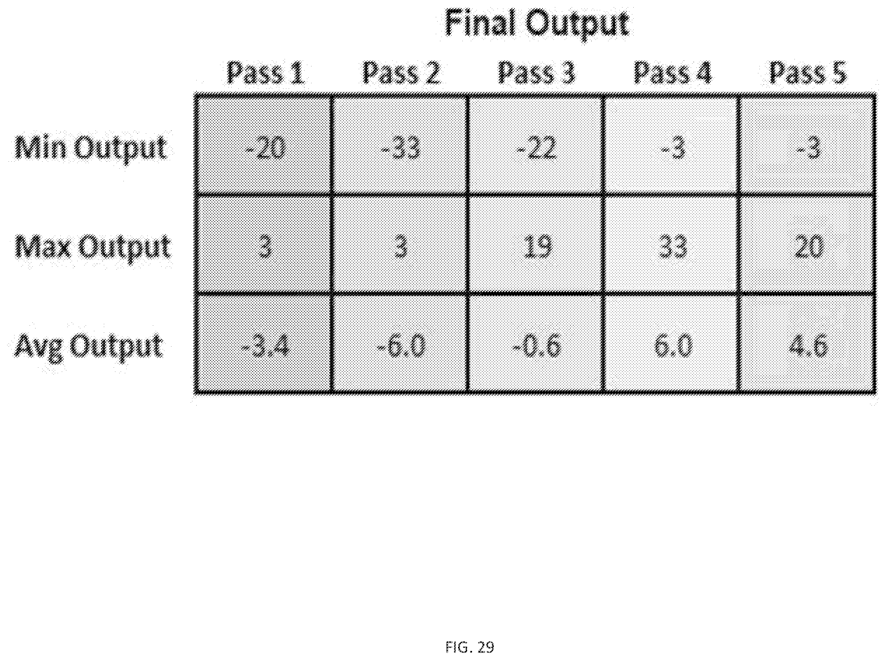

Blue cells are populated with raw values are [3, −20, −3, 0, 3]. When using the Min Pool operation, these raw values are condensed to a single value −20, which is the minimum value of the five original values. Similarly, when using the Max Pool operation, these raw values are condensed to a single value of 3, which is the maximum value of the five original values. Likewise, when using the Average Pool operation, these raw values are condensed to −3.4, which is the average value of the five original values. Therefore, for a raw signal contained within the blue cells, the server 104 has condensed these five original values into a single value for each type of the pooling operations. Accordingly, applying these pooling operations to the data sequence (still color-coded) results in an output, as shown in FIG. 29.

A Learnable Pool (or pooling) is a pooling operation. For example, the Learnable Pool can be included in or be embodied as a pooling layer, whether alone or with other pools. Like the pooling operations, as described above, the Learnable Pool operation uses the pool size and the stride factor to determine which adjacent values will be condensed. However, unlike the pooling operations described above, the Learnable Pool operation differs in a mathematical operation that is used to condense the adjacent values, which can be independent of the pooling operations, as described above. For example, the Learnable Pool can include a layer within an ANN that performs a pooling operation (e.g., a pooling operation that is trainable). For example, the Learnable Pool can include a trainable bias term. For example, the mathematical operation can include a linear operation, an exponential operation, a logarithm operation, a power modulus operation, a trigonometric operation, or others. Note that since the pooling operation is a learned operation that includes a non-linearity, there are many possibilities therefor. Rather than executing a mathematical computation (e.g., minimum, maximum, average), the mathematical operation that gets executed by the Learnable Pool operation is learned by an ANN. For example, this learning can occur, as disclosed herein. For example, the Learnable Pool can be programmed to determine a content prediction or presence or absence based on a particular set of extracted or identified or non-extracted or non-identified features (or other characteristics). For example, the Learnable Pool can include a set of pooling models that each programmed to generate a content prediction or presence or absence based a pooling model. For example, the Learnable Pool can be programmed to output a multi-model prediction based on a content prediction from a pooling model. In some cases, a combined prediction can be based on the multi-model prediction received from each member of a set of Learnable Pools. For example, the pooling model can be of various types including learned ensembles, logistic regression, reinforcement learning, or any other suitable technique. For example, the Learnable Pool can be programmed to read or analyze a content or a set of features thereof and then generate a corresponding feature vector. For example, the Learnable Pool can include or be embodied as various learnable pooling techniques including a Soft Bag-of-words technique, a net Fisher Vector (NetFV) technique, a new trainable generalized vector of locally aggregated descriptors (NetVLAD) technique, a residual-less vector of locally aggregated descriptors (NetRVLAD), a gated recurrent unit (GRU) technique, and a long short-term memory (LSTM) technique, or any other suitable modeling technique.

The Learning Pool operation contains learnable weights. These learnable weights are adjusted by an ANN during training time in a same way that other learnable parameters are adjusted. When and how these learnable weights are applied to the adjacent values is what governs how the adjacent values are condensed. Although the pooling operations that are described above (e.g., Min Pool, Max Pool, Average Pool) are sometimes effective, the Learnable Pool operation can also be used, whether additionally or alternatively, but would eventually learn to perform that mathematical operation of other pooling operations (e.g., finding a maximum value). For example, if, for a given problem, the Max Pool operation was an effective pooling technique, but the Learning Pool operation was used, there is an expectation that the Learnable Pool operation would eventually learn to perform that simple mathematical operation of finding a desired value (e.g., finding a maximum, minimum, or average value). For example, if a user (e.g., a data scientist) knows ahead of time, based on domain knowledge, that a maximum value is an important or most important feature, then its more efficient to use a Max Pool operation ab initio. However, the Learnable Pool operation is technologically advantageous because there are many variations of its operations, some of which are explained below.

One example of variation of the Learnable Pool operation is a convolution with a learnable activation function. In this example, the Learnable Pool operation is extremely effective and has a low computational cost. This Learnable Pool operation includes a Convolutional Neuron with strides and kernel size set to the pool size with a learnable activation applied to the Convolutional Neuron.

An activation function is an important feature of an ANN. The activation function is what decides whether a neuron should be activated (1) or not (0). A learned activation function is one where some aspect of how the learned activation function decides whether a neuron should be activated is learned.

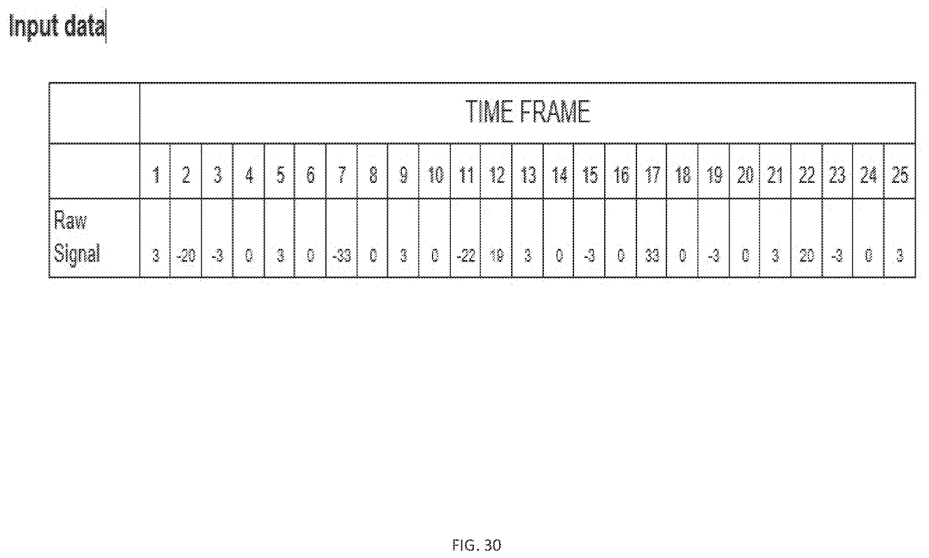

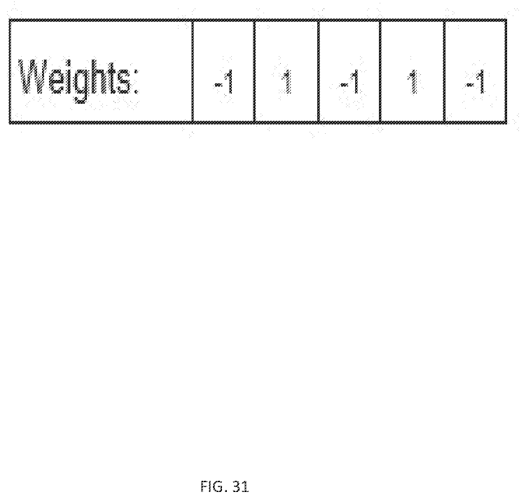

For a set of input data shown in FIG. 30, there is a set of hyperparameters set or selected by a user (e.g., a data scientist). The set of hyperparameters includes a Downsample Factor (pool size) of 5, a Kernel size of 5*1 blocks of data (sequence units*number of signal streams) and a number of Strides 5 (equal to the kernel size to prevent data overlap). Likewise, as shown in FIG. 31, there is a set of learned parameters. In particular, the set of learned parameters includes 5 learned weights (per the kernel size set by the user), one for each block. An ANN learns these weights in a same way that the ANN learns other weights, by applying adjustments to these weights during a training process as prescribed by a loss function provided by the user. Similarly, there is an alpha value, which is a learned parameter in the activation function, having a value of −1.

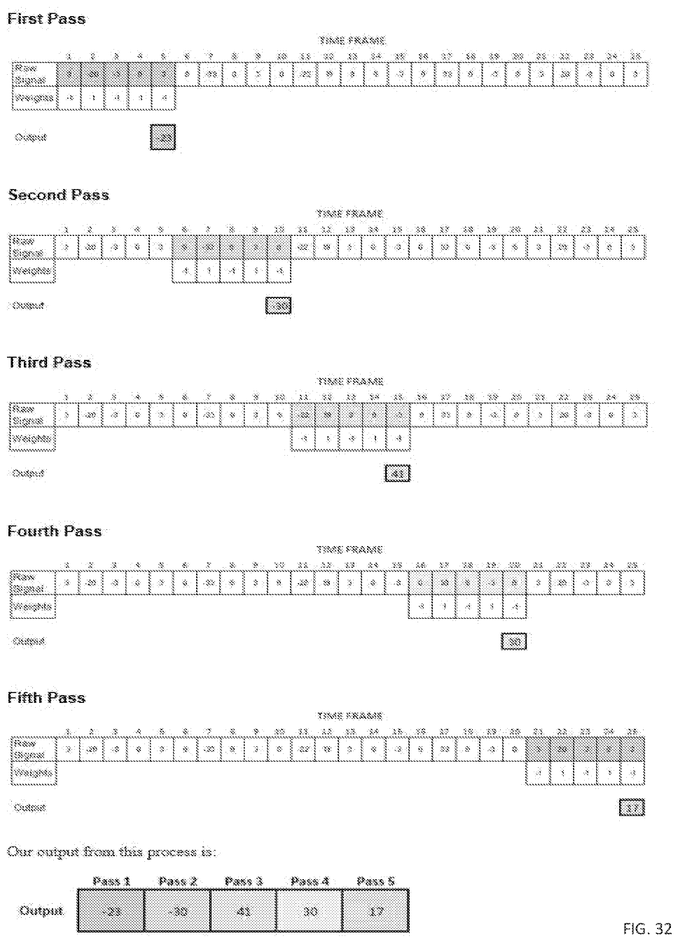

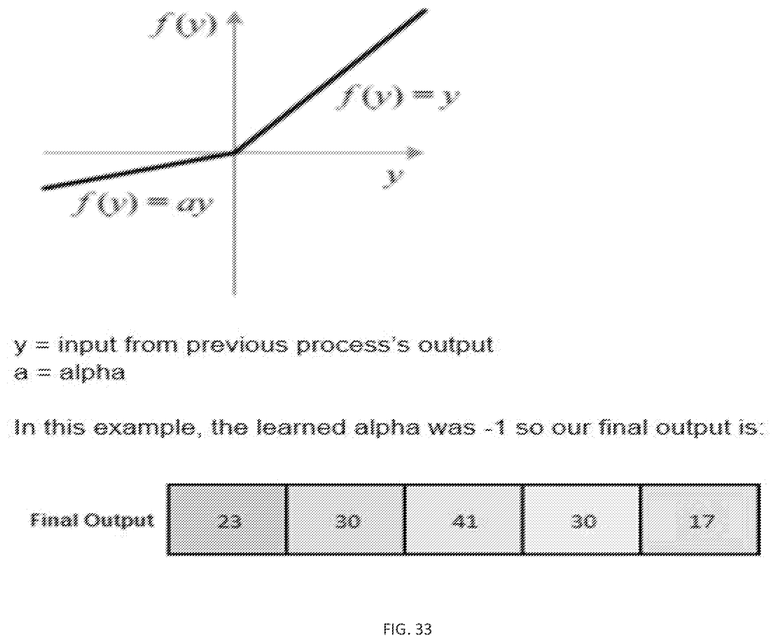

As shown in FIG. 32, there are five convolution passes. For example, the first pass of these five passes has an output that is determined to be (3*−1)+(−20*1)+(−3*−1)+(0*1)+(3*−1)=−23. Similar computational operations occur for remaining four passes of these five passes, where an output for the second pass is −30, an output for the third pass is 41, an output for the fourth pass is 30, and an output for the fifth pass is 17. Resultantly, each of these outputs can be combined into an array (or another data structure) and sent through a Parametric Rectified Linear Unit (PReLU), which is an activation function that generalizes a traditional rectified unit with a slope for negative values. The PReLU Activation Function which is shown in FIG. 33 together with a final output (note that negative values became positive based on the alpha value). Therefore, as demonstrated above, various features captured by this technique are different from those that are captured by this and the other previously shown pooling methods. The values here in the first three passes, for example, are larger than those captured by the Min Pool operation, the Max Pool operation, and the Average Pool operation. Those larger values correlate with clinically significant events, as disclosed herein.

Another example of variation of the Learnable Pool operation is a convolution within a convolution (e.g., a nested convolution within a CNN) with a Global Max pooling operation. In this example, this more complex learnable pool (relative to above) shows how variations in a convolutional kernel can be used to solve specific domain problems. This pool include a Convolutional Neuron that is convolved within each pool in order to isolate temporally shifted signals. A set of final values is condensed using the Global Max Pooling operation to still provide a single final value. As explained above, the Max Pooling operation is an operation that condenses adjacent values into a single value by choosing a maximum value amongst those adjacent values. The Global Max pooling operation is a shortcut for having the pool size being set to a size of a full sequence of data. The Global Max pooling is used to aggressively summarize a presence of a feature.

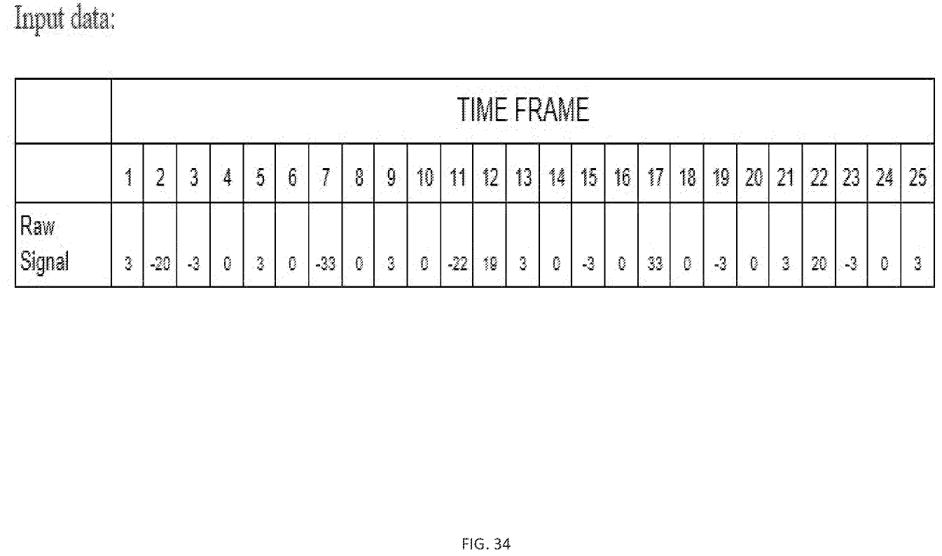

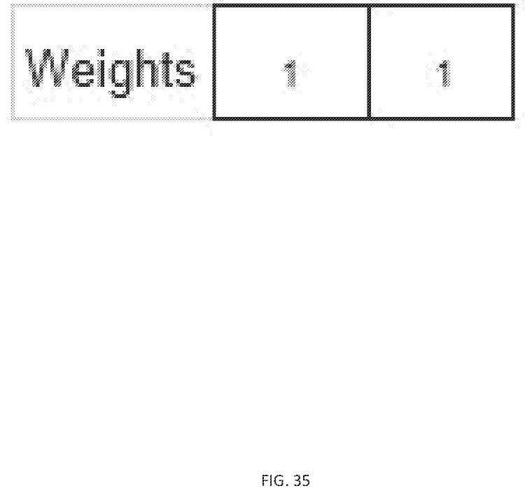

For a set of input data shown in FIG. 34, there is a set of hyperparameters set or selected by a user (e.g., a data scientist). The set of hyperparameters includes a set of outer hyperparameters inclusive of a Downsample Factor of 5 (equivalent to pool size), a Kernel size of 51 blocks of data (sequence units*number of signal streams), and a number of Strides 5 (equal to the kernel size to prevent data overlap). The set of hyperparameters includes a set of inner hyperparameters inclusive of a Kernel size of 21 blocks of data (sequence units*number of signal streams) and a number of Strides 1 (allowing data overlap). There is also a set of learned parameters. In particular, as shown in FIG. 35, the set of learned parameters includes 2 learned weights (per the kernel size set by the user), one for each block. As such, an ANN learns these weights in a same way that the ANN learns other weights, by applying adjustments to these weights during a training process as prescribed by a loss function provided by the user.

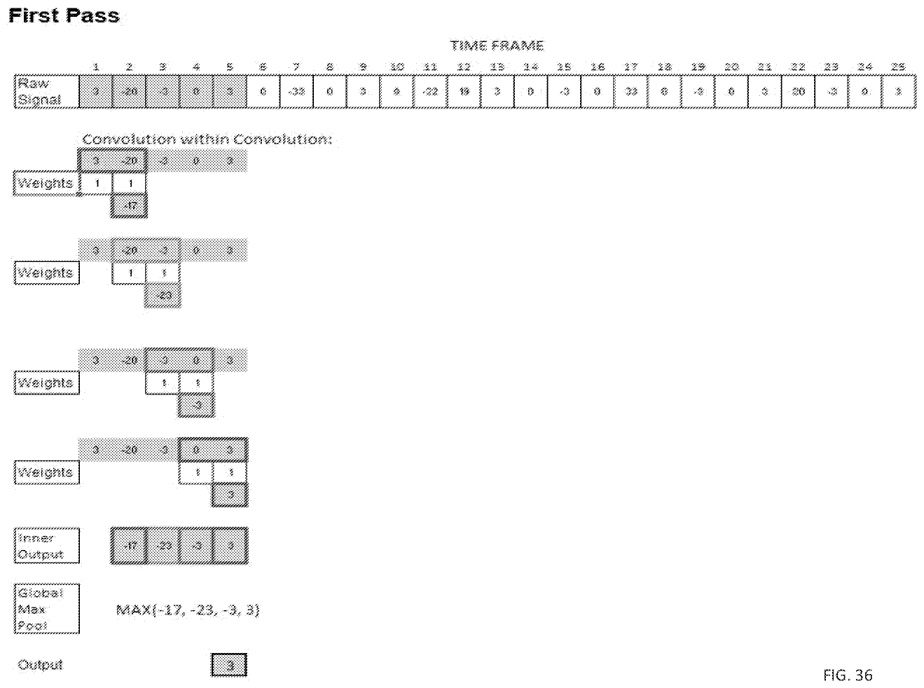

The Learnable Pool operation of the convolution within the convolution (nested convolution) with the Global Max pooling operation includes a process, as shown in FIGS. 36-41. The process includes an outer convolutional process similar or identical to one shown in FIGS. 29-33, where values from 5 consecutive units of a data sequence are processed at a time, following a specified pool size and stride factor. The process further includes an inner convolutional is processed by summing together the two learned weights by the two values in the data sequence. The process further includes having the five sums from the previous step being coalesced into a single value using the Global Max Pooling operation as described above. This value is forms an output of the outer convolutional process. Therefore, as demonstrated above, various features captured by this method are similar to those captured by the Max Pool operation. Through typical trial and experimentation, the user may discover that this Learnable Pool operation has a higher efficacy. Why this Learnable Pool and other Learnable Pools is technologically advantageous is further disclosed below in context of combining base pooling and Learnable Pools.

Yet another example of variation of the Learnable Pool operation is a RNN within a convolution (e.g., a CNN). In this example, a Recurrent Neuron is used as a core of a pooling operation. This demonstrates how even a non-convolutional neuron can be utilized as a Learnable Pool operation. This Recurrent Neuron is run within a designated pooling area as set or selected by a user (e.g., a data scientist) and a produced value is used as a value for an entire pooling operation.

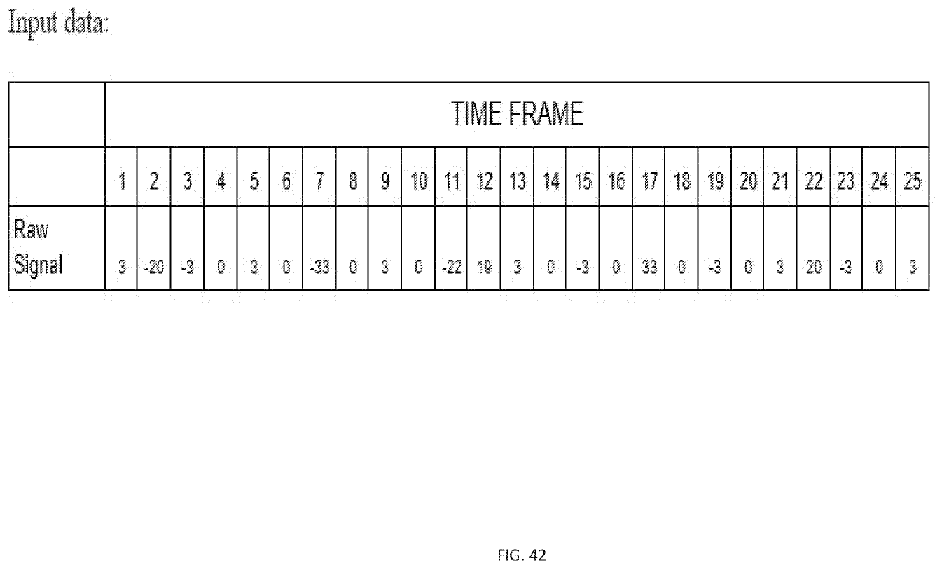

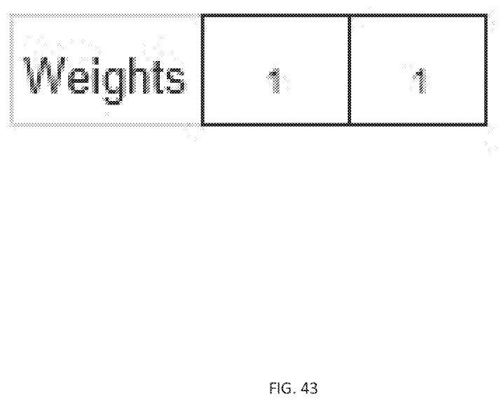

For a set of input data shown in FIG. 42, there is a set of hyperparameters set or selected by a user (e.g., a data scientist). The set of hyperparameters includes a Downsample Factor of 5 (equivalent to pool size). The set of hyperparameters includes a set of outer convolutional hyperparameters. The set of outer convolutional hyperparameters includes a Kernel size of 51 blocks of data (sequence units*number of signal streams) and a number of Strides 1 (equal to stride to avoid data overlap). The set hyperparameters includes a set of RNN (inner) parameters where an initial recurrent state is set to 0. The set of hyperparameters includes a set of learned parameters. In particular, as shown in FIG. 43, the set of learned parameters includes 2 learned weights (per kernel size set by the user), one for each block. An ANN learns these weights in a same way that the ANN learns other weights, by applying adjustments to these weights during a training process as prescribed by a loss function provided by the user.

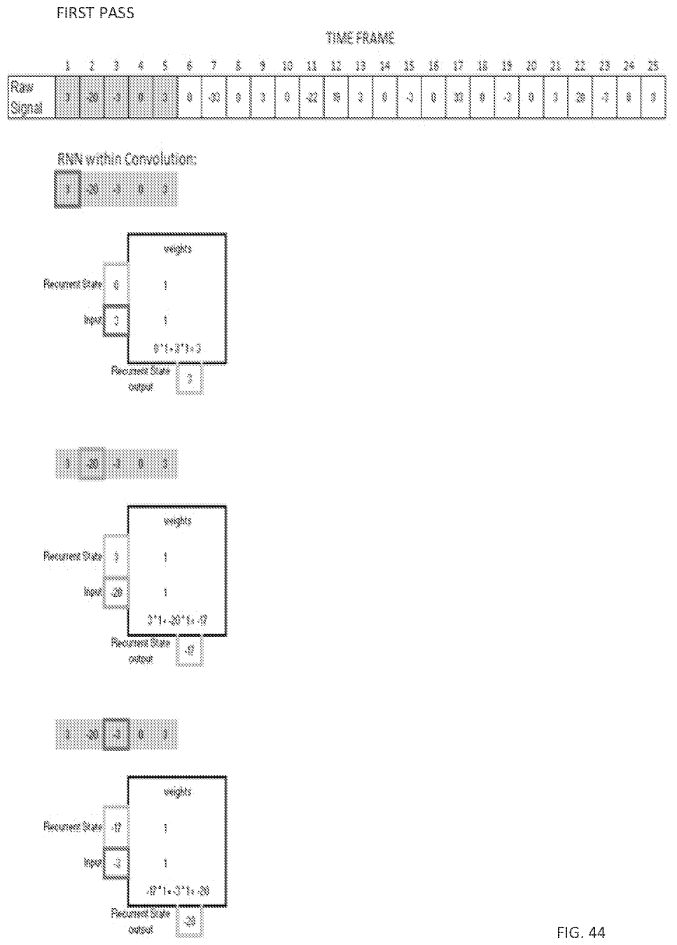

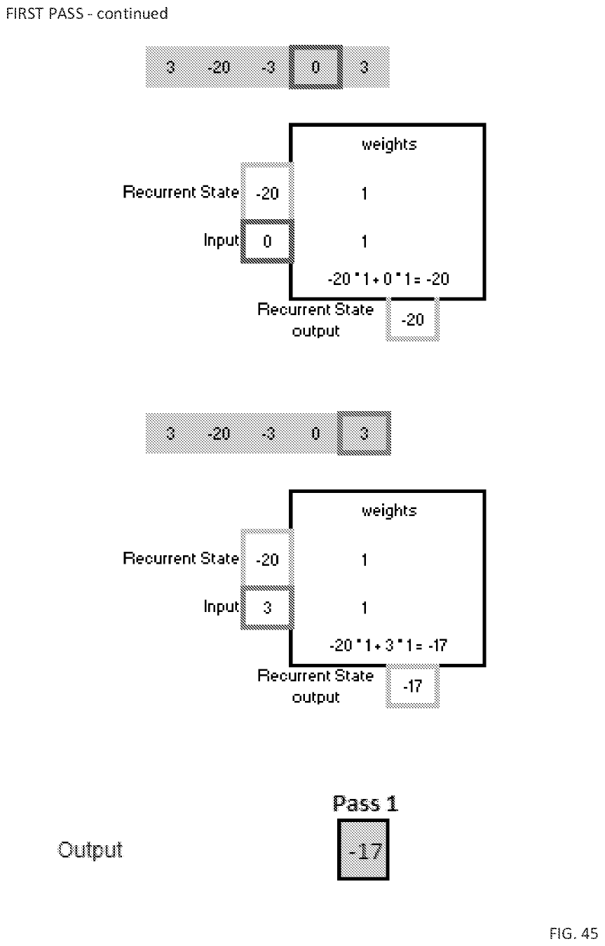

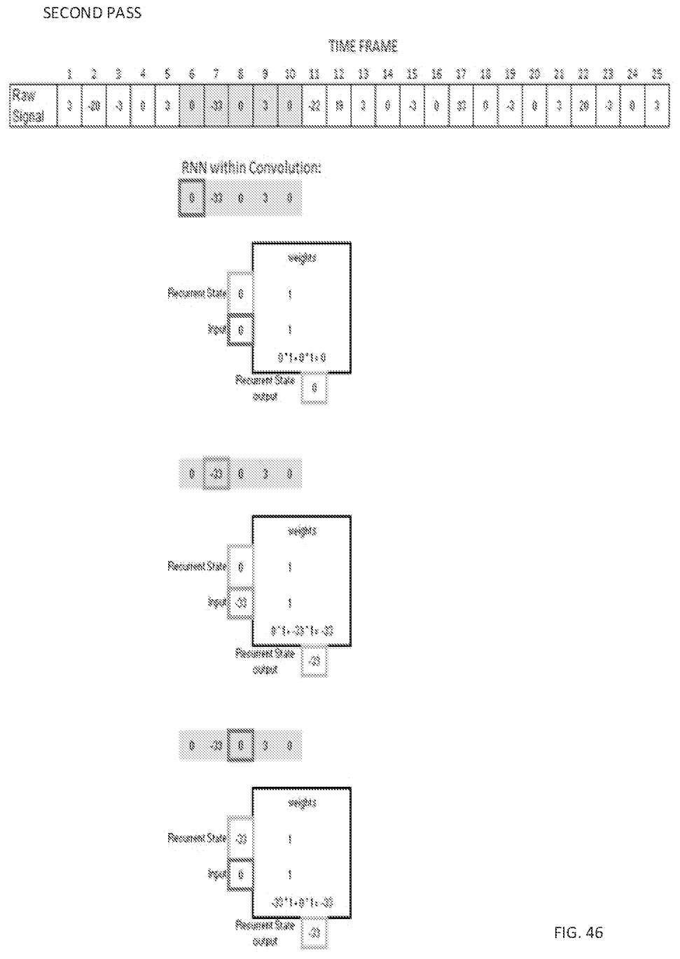

The Learnable Pool operation with the RNN within the convolution includes a process, as shown in FIGS. 44-48. The process includes an outer convolutional process similar or identical to one shown in FIGS. 29-33 or FIGS. 34-41. Per the kernel size and the stride value, the process creates chunks of 5 units in a data sequence to be processed at a time by the RNN. The process includes the RNN layer iterating through the 5 units sequentially. This iteration includes the recurrent state, initially set to zero, is multiplied by the recurrent state's learned weight, the individual sequence value is multiplied by the input's learned weight, those numbers are summed and this total is the new recurrent state. The RNN process repeats through all data provided by the CNN (outer). The end value of the recurrent state is the output of the outer process. Note that the first pass is shown in FIGS. 44-45, the second pass is shown in FIGS. 45-46. Therefore, as demonstrated above, the features captured by this process are different from those that are captured by the other previously shown pooling processes. The values here in the third pass, for example, are different than any captured by the Min Pool operation, the Max Pool operation, and the Average Pool operation. The values in the first pass and the second pass look similar to the Min Pool operation, while those in the fourth pass and the fifth pass look similar to the Max Pool operation. In combination with the Min Pool operation and the Max Pool operation, the mere fact of their similarity and differences are a feature that they may correlate with clinically significant events (or non-clinically significant event based on context and environment), as further described below. Note that by combining various Convolutional and Recurrent processes with different Activation Functions or extra pooling processes (e.g., Global Max Pooling, Global Min Pooling, Global Average Pooling) along with different Downsample Factors, the number of possible Learnable Pools is only limited by the creativity of a user (e.g., a data scientist). Since experimentation with pooling strategies appears to be generally rare in data science learning materials and literature, this may be a fertile area for innovation with practical value by adding new signal discrimination capabilities, as further described below.

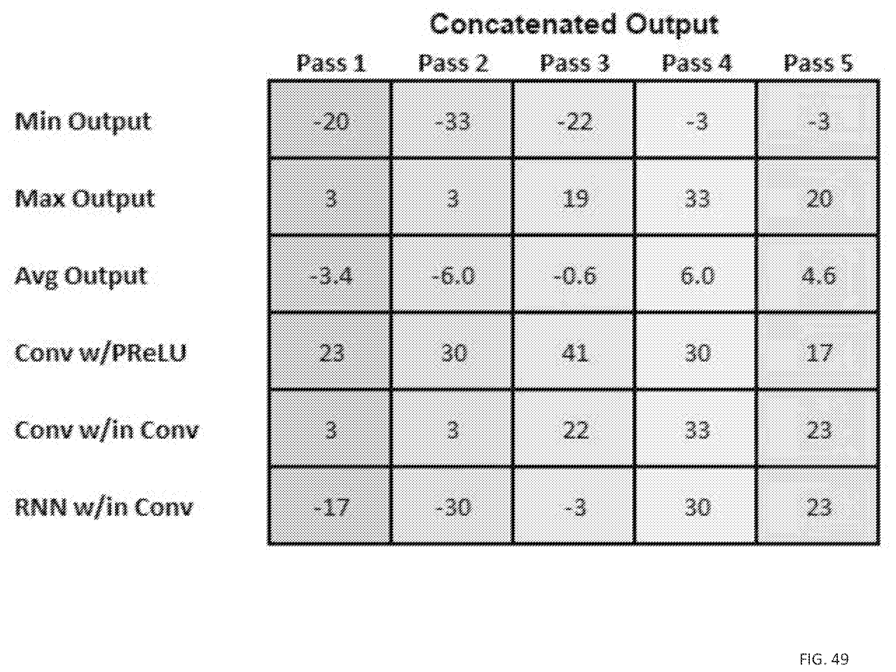

Basic Pooling (e.g., Min Pool, Max Pool, Average Pool) and Learnable Pool (e.g., a convolution with a learnable activation function, a convolution within a convolution, a RNN within a convolution) can be combined. In particular, as explained above, there is a disclosure of how pooling works, how learnable pooling techniques work, and various (e.g., at least three) specific learnable pooling implementations. Therefore, FIG. 49 shows a concatenated output from all of these techniques together in a single table. At this point, there is a disclosure of how, by implementing (1) a Min pooling operation, a Max pooling operation, an Average pooling operation, or another pooling operation, and (2) a Learnable pooling technique (Learnable Pool), together in concert (e.g., serially, concurrently), may be used to achieve a goal of downsampling a set of data without sacrificing (or while minimally sacrificing) an ANN's ability to detect signals that occur at varying frequencies.

In order to maximize various technological advantages of pooling, various techniques disclosed herein should be (but don't have to be) implemented early in an ANN in terms of order in which a set of layers are processed. For example, some of these techniques can be implemented as early as possible. While ANN architectures differ, generally speaking, these architectures begin with one or more input layers, then various number of hidden layers, then one or more output layers. This operation will typically happen amongst or immediately following the input layers. Through either outside knowledge or typical experimentation, a user sets or selects a downsample factor to best align together a set of subcomponents of a lowest frequency event. For example, in an EEG domain, if a neurologist generally agrees that a most clinically relevant signal occurs below about 10 Hz and an EEG reading is recorded at about 200 Hz, then 20 may be a good or sufficient initial downsample factor. This factor can be used for a pooling level for a Max pooling operation, a Min pooling operation, an Average pooling operation, and a Learnable Pool.

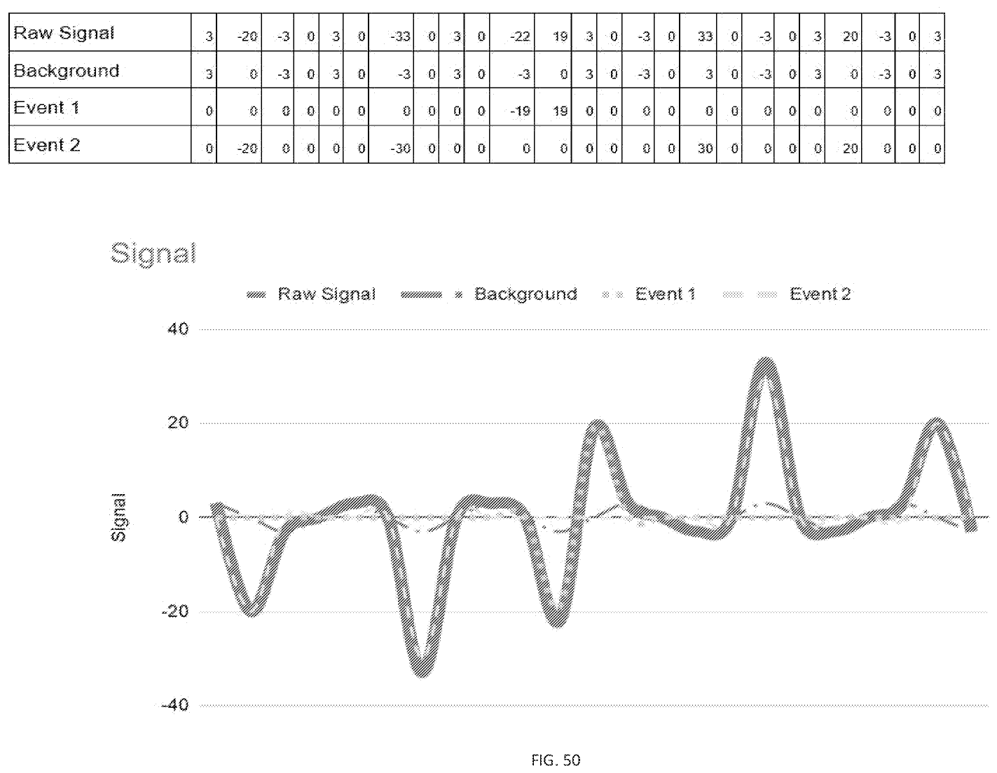

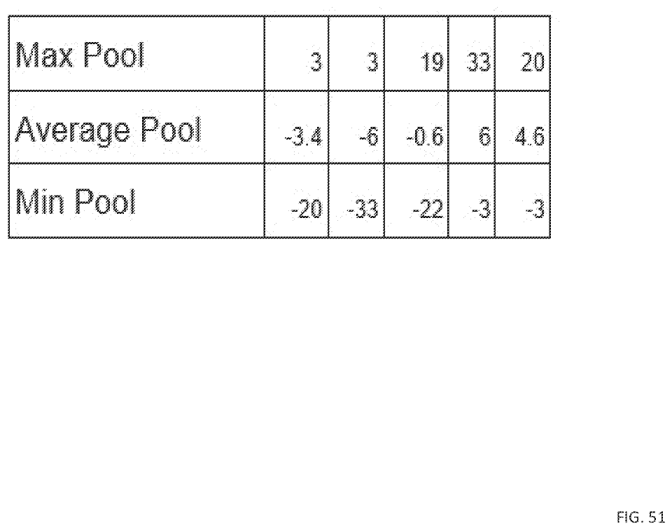

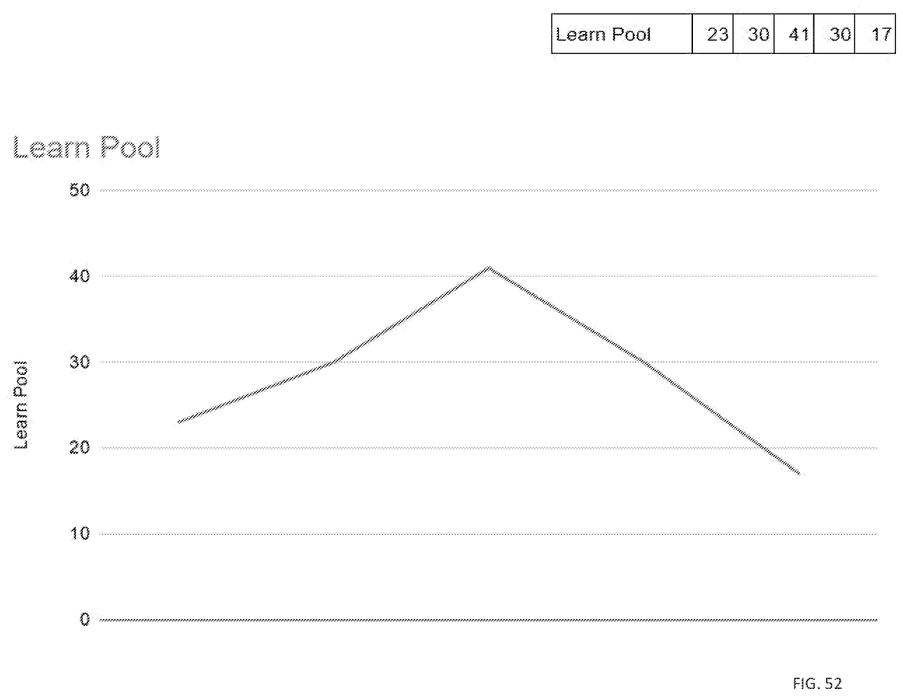

Taking again an example from above, as shown in FIG. 50 (e.g., X-axis is units of time and Y-axis is signal value), there is a signal with two events where Event 1 is best viewed at a raw sampling rate and Event 2 is best viewed with a downsample factor of 5. Starting with a set of basic pools (e.g., a Max pooling operation, a Min pooling operation, an Average pooling operation), there is a determination of an output for each member of the set of those basic pools, assuming a downsample factor of 5, as shown in FIG. 51. In this case, the Learnable Pool is a specialized Convolutional Neuron Variant, the most basic of which simply has a stride and a kernel size equal to the downsample factor. For this example, the Learnable Pool has weights [−1,1,−1,1,−1] with a PReLU activation with an alpha of −1 to better identify Event 1, as shown in FIG. 52 (e.g., X-axis is units of time and Y-axis is learnable pool output value). Each of four pooling groups (e.g., Max, Min, Average, Learnable) are then separately applied to an input sequence, with their respective outputs being concatenated together (e.g., joining values or sets of data end-to-end) for consumption by immediately adjacent, later, or subsequent layers of an ANN. For example, some or any layer that is executed sequentially after the pooling operation may use the output of the pooling operation. Typically, the layer or only the layer immediately following will use the output of the pooling operation, but a user (e.g., data scientist) is not limited in this approach, since the execution of an ANN is either procedural or functional, but in either case is constructed in a declarative manner. FIG. 52 shows a final output of this operation superimposed on an original signal.

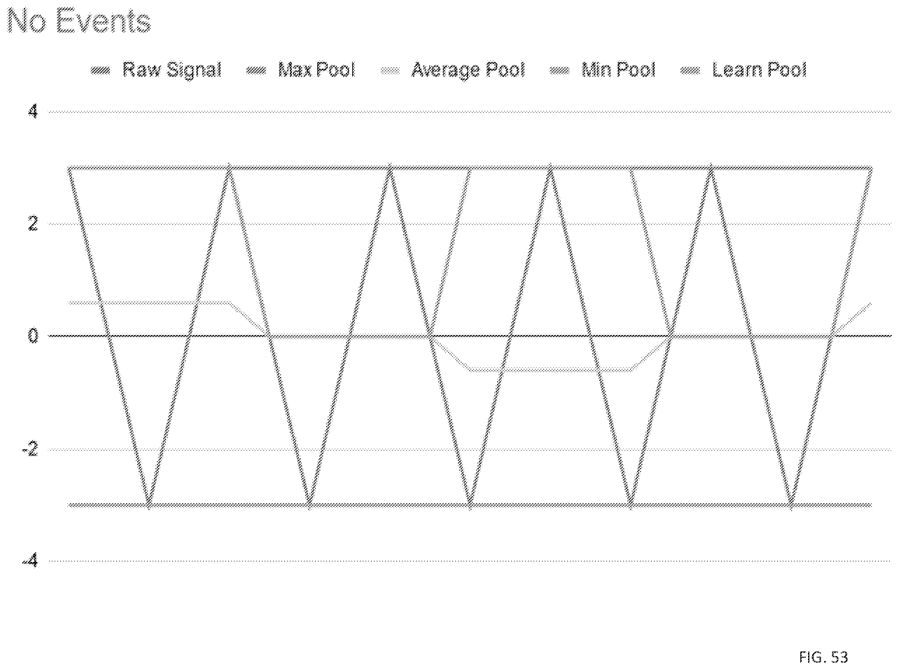

As shown below, this usage of a Learnable Pool evidences effective solution to various technological problems presented above, thereby enabling an ANN to downsample without losing (or minimally losing) its ability to discriminate between at least two events occurring at different frequencies (or other data forms, formats, discretion, or tokenization). As explained above, this technique can include a pooling layer that utilizes or includes at least one of (1) a Max pooling operation, an Average pooling operation, a Min pooling operation, or another pooling operation, and (2) a Learnable pool, in concert, to provide downsampling, as disclosed herein. Contrast graphs of FIGS. 53-56, each of which plot an output of this technique when this technique is applied sample data, as described.

FIG. 53 shows a plot (e.g., X-axis is units of time and Y-axis is signal value) of an output of this technique with no events readily discernible or readily identifiable, i.e., when a set of sample data contains neither Event 1 nor Event 2. Note that the Y-axis has no value within the output that is greater than 3 or less than −3.

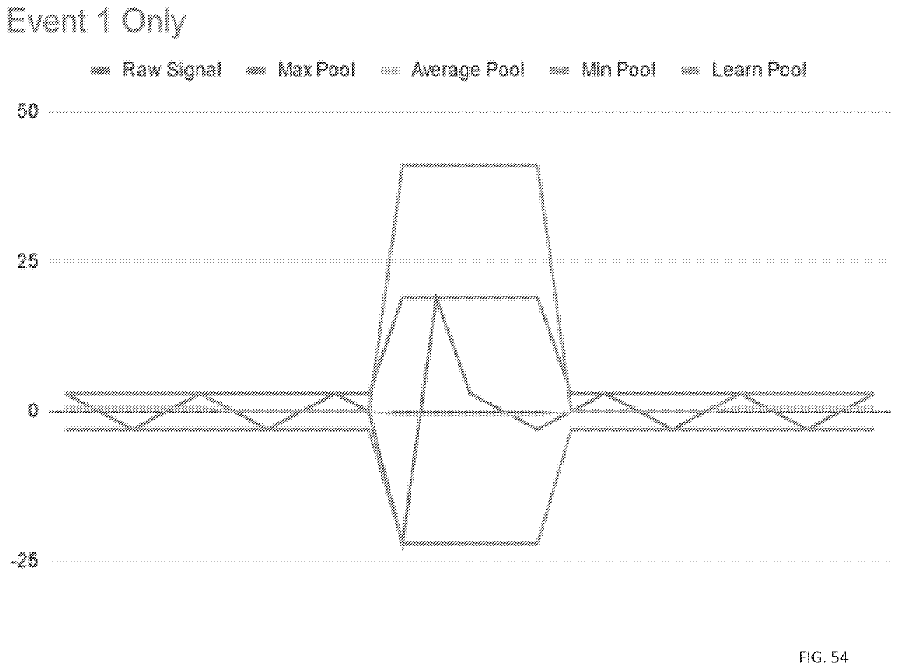

FIG. 54 shows a plot (e.g., X-axis is units of time and Y-axis is signal value) of an output of this technique with only Event 1 being readily discernible or readily identifiable, i.e., when a set of sample data only contains Event 1. If Event 1 occurs during some time period, then this technique enables the output to indicate that Event 1 has occurred. Note that this plot is readily distinguishable from Plot 1 of FIG. 53.

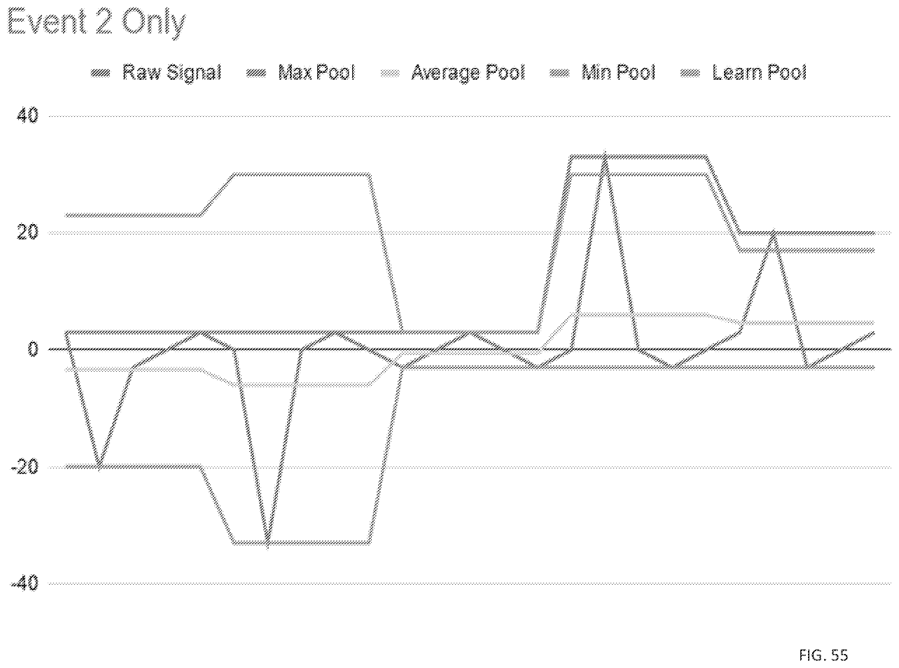

FIG. 55 shows a plot (e.g., X-axis is units of time and Y-axis is signal value) of an output of this technique with only Event 2 being readily discernible or readily identifiable, i.e., when a set of sample data only contains Event 2. If Event 2 occurs during some time period, then this technique enables the output to indicate that Event 2 has occurred. The Min pool operation and the Max pool operation are very active during this timeframe, as is the Learnable Pool. Note that this plot is readily distinguishable from both plots 1 of FIG. 53 and plot 2 of FIG. 54.

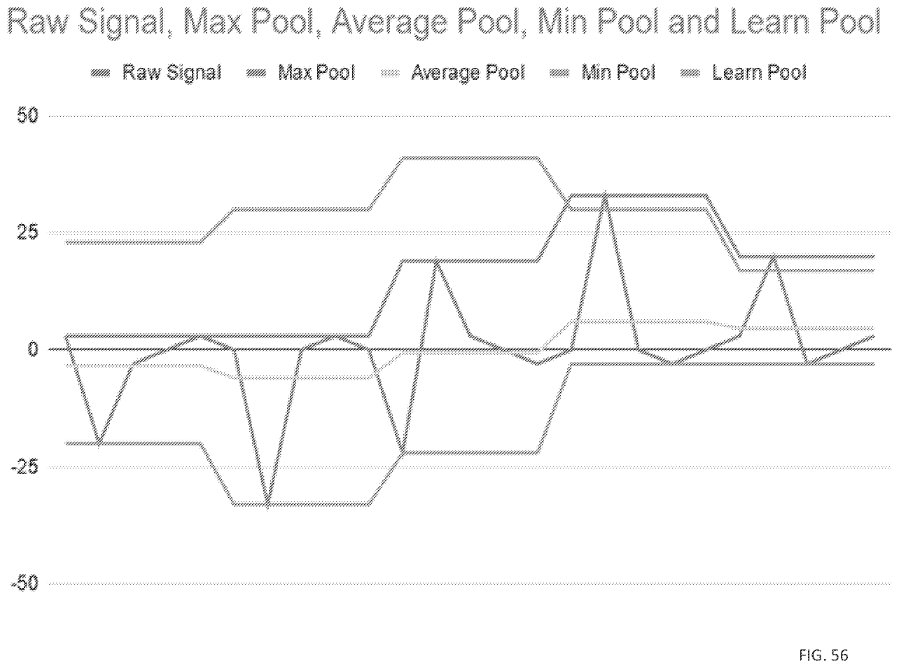

FIG. 56 shows a plot (e.g., X-axis is units of time and Y-axis is signal value) of an output of this technique with both Event 1 and Event 2 being readily discernible or readily identifiable, i.e., when a set of sample data contains both Event 1 and Event 2. If both Event 1 and Event 2 occurs during some time period, then this technique enables the output to indicate that both events (Event 1 and Event 2) occurred. Note that this plot is readily distinguishable from plot 1 of FIG. 53, plot 2 of FIG. 54, and plot 3 of FIG. 55.

As explained above, various conventional downsampling techniques are technologically deficient in their abilities to create outputs in which multiple events occurring at frequencies that vary widely may be readily discerned. However, when various pooling techniques, as explained herein, are applied to those very same data, then these pooling techniques produce various outputs in which those original events, in any combination, may readily be discerned. These technological advantages occur based on a process of combining these various pooling operations to classify various waveform variations. These abilities to classify waveform variations are what allow an ANN to detect specific events within a data stream (or sequence) which in turn gives the ANN a capability of discriminating between classes.

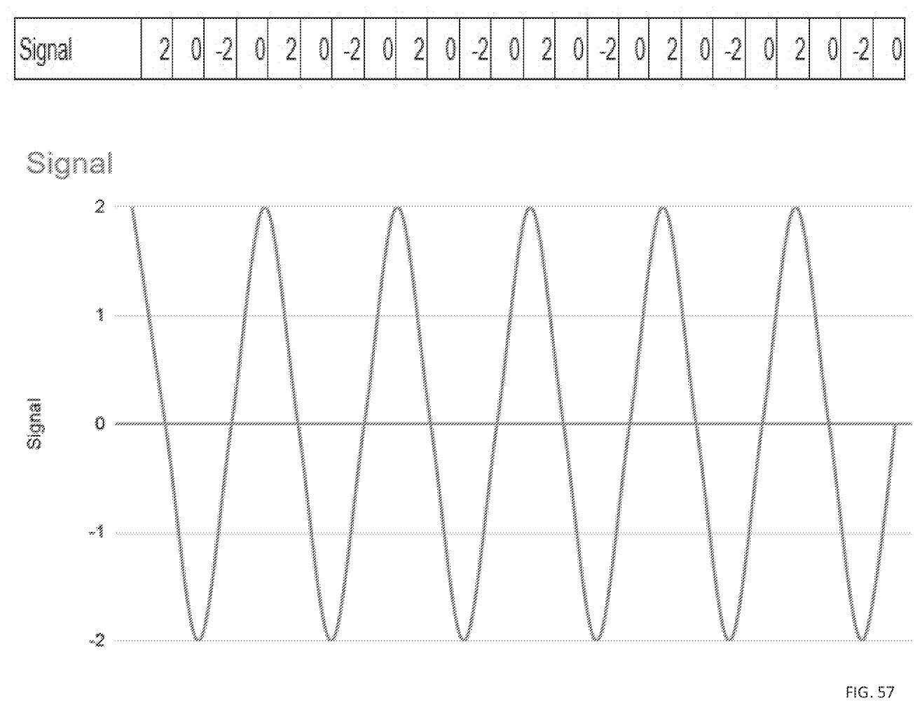

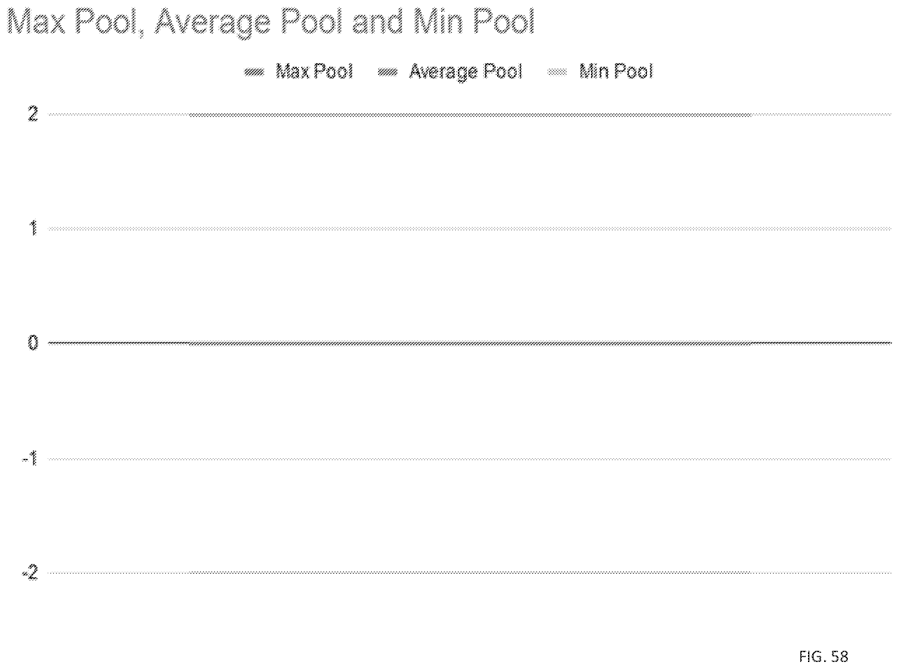

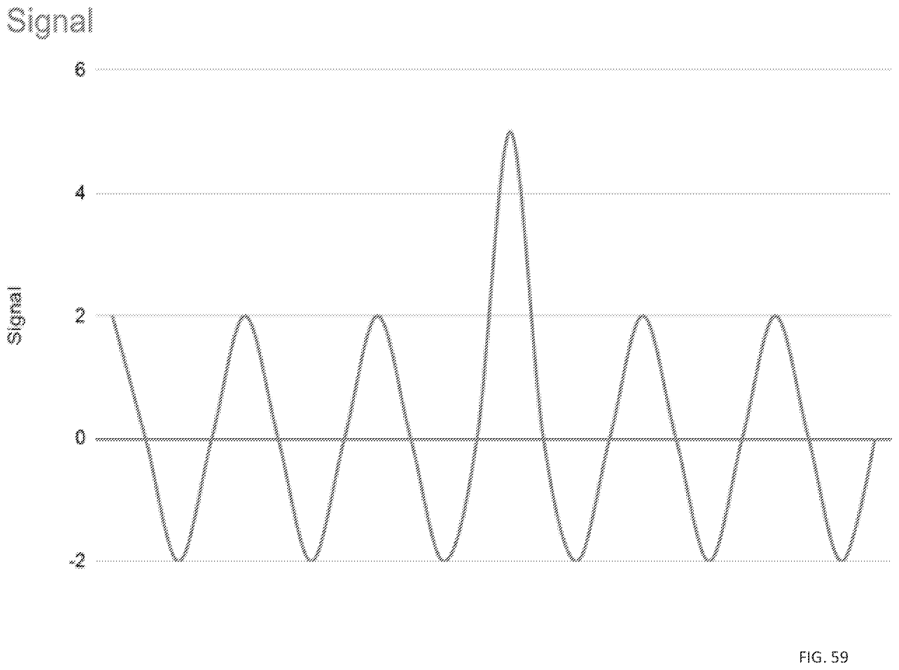

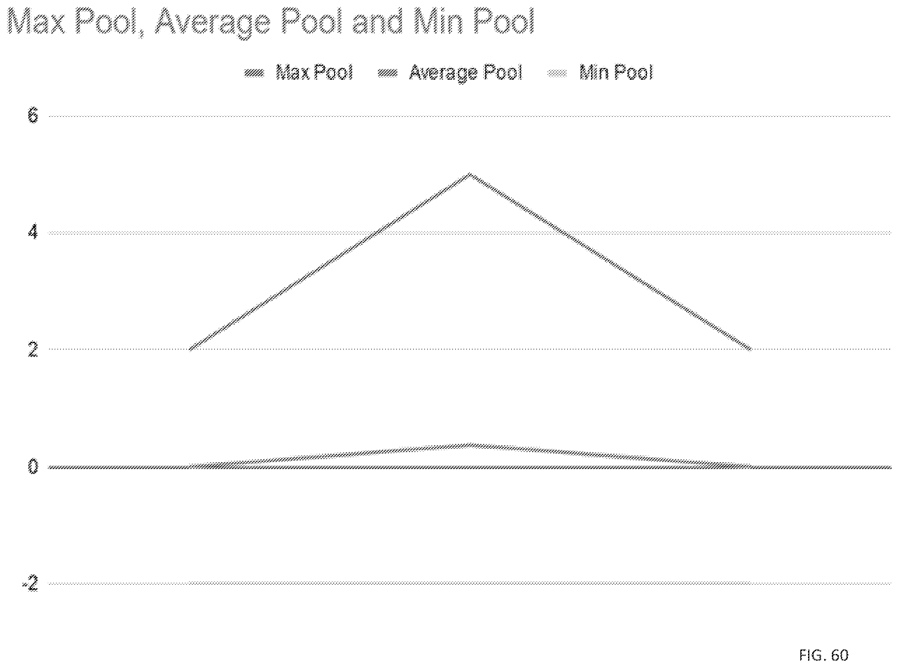

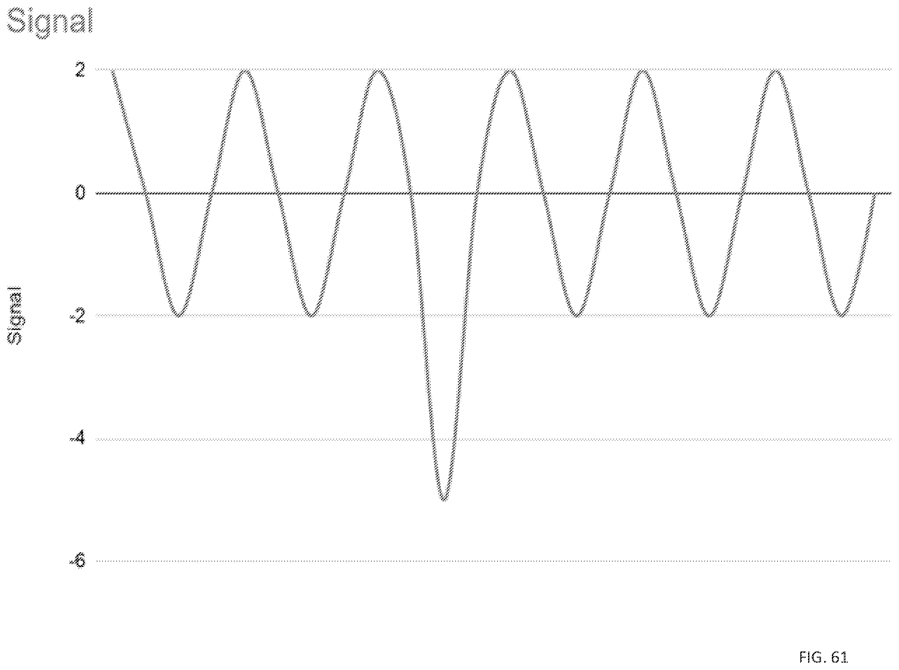

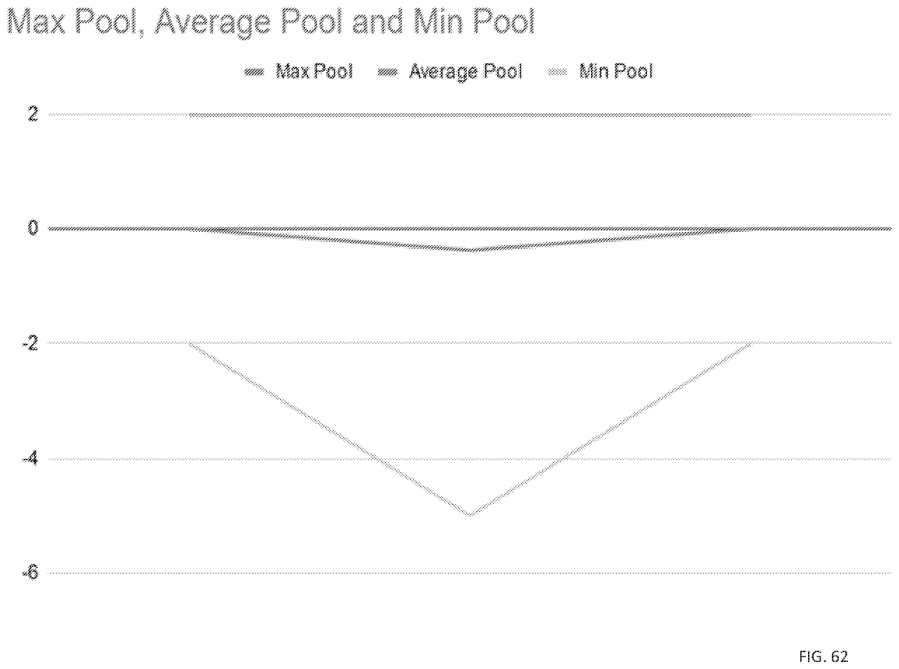

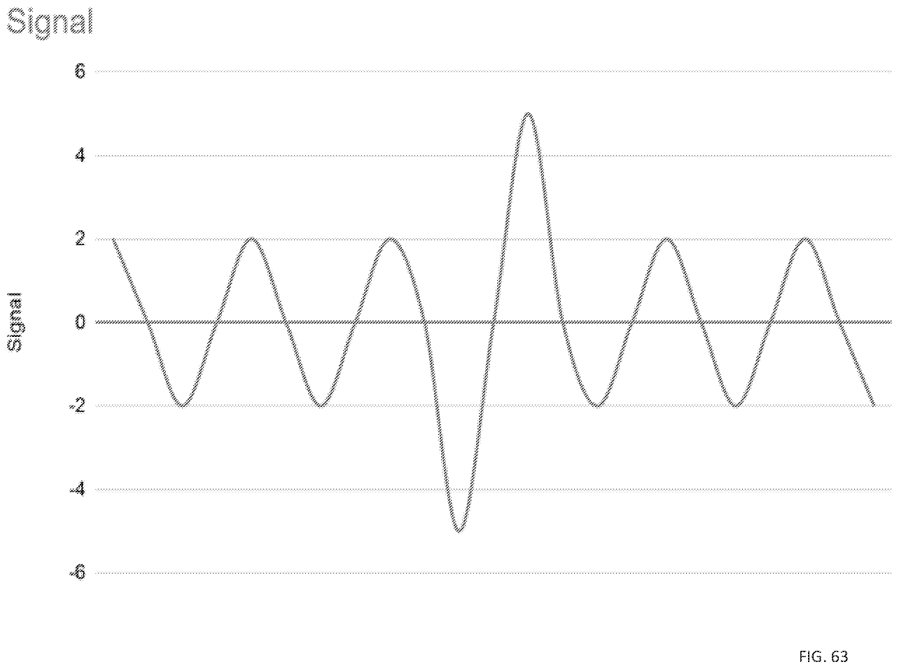

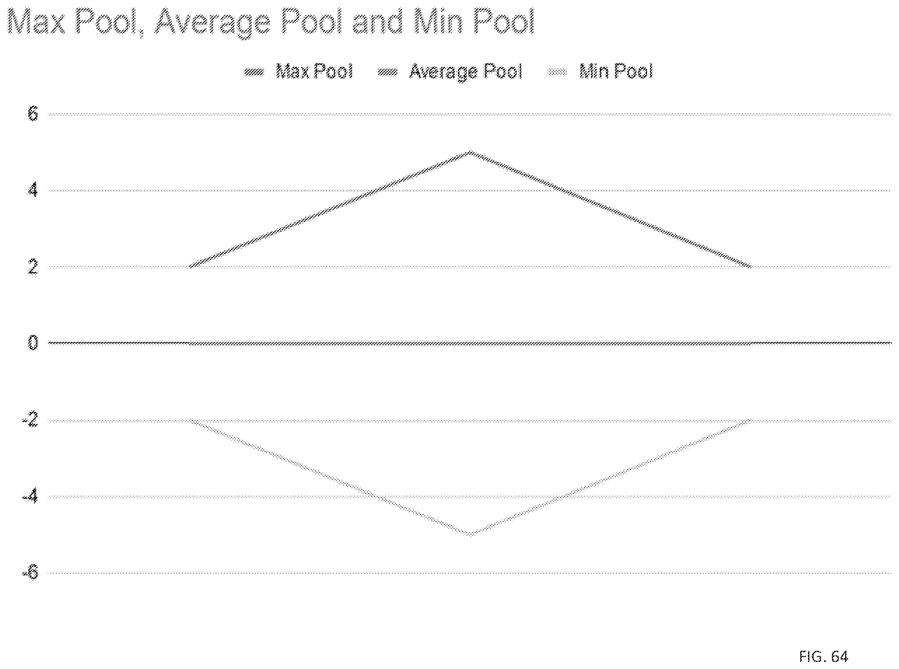

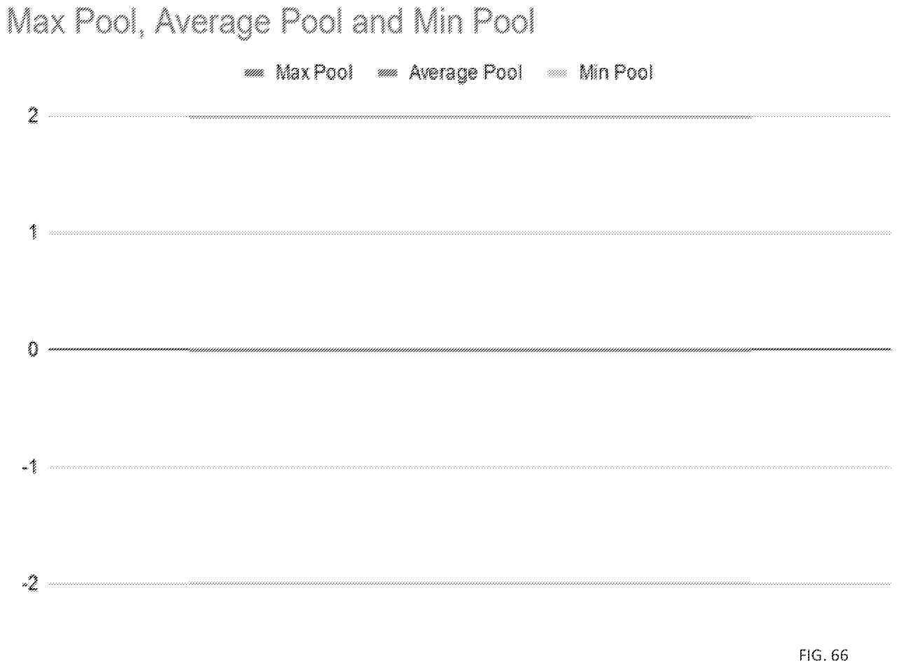

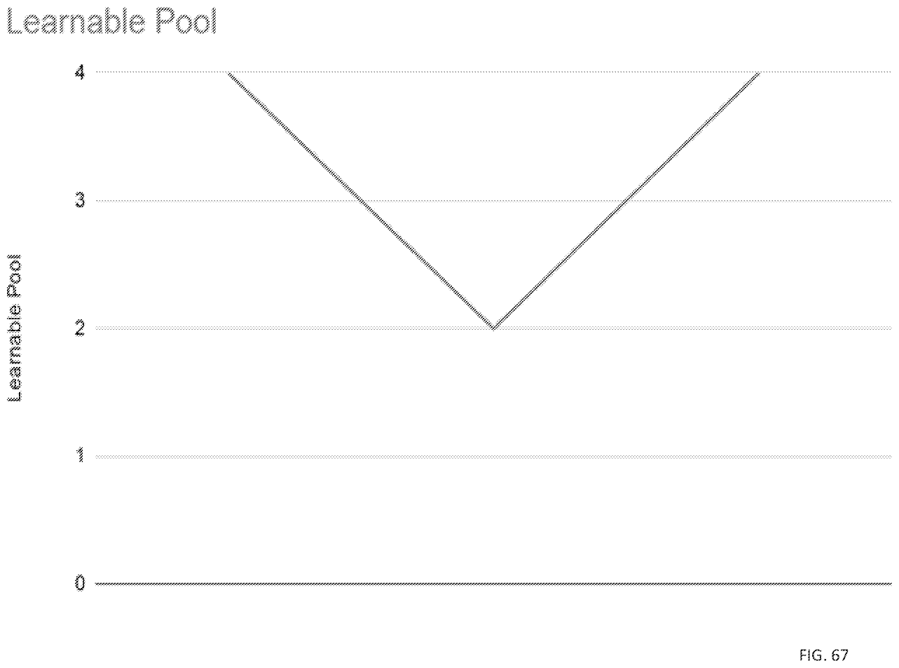

For example, using a waveform of FIG. 57, there is a plot of baseline pools for this signal, assuming a downsample rate of 8, as shown in FIG. 58. With respect to a Max pooling operation and an Average Pooling operation, when the waveform changes by increasing a positive amplitude, there is a corresponding increase in the Max pooling operation and the Average pooling operation, but without a change in a Min pooling operation, as shown in FIG. 59 and FIG. 60. With respect to the Min pooling operation and the Average pooling operation, inversely, when a negative amplitude of the waveform decreases, there is a corresponding a decrease in the Min pooling operation and the Average pooling operation, but without a corresponding movement for the Max pooling operation, as shown in FIG. 61 and FIG. 62. With respect to the Max pooling operation and the Min pooling operation, similarly, if there is an equal change in both positive and negative amplitudes of the waveform, then there is a corresponding Max pool operation increase, the Min pool operation decrease, and the Average pooling operation stay same, as shown in FIG. 63 and FIG. 64. However, with respect to a Learnable Pool, there are other waveform variations that are not represented by these simple pools, as shown in FIG. 57 to FIG. 64. For those situations, the Learnable Pool is helpful. For example, take an inverse of FIG. 63, there is an isolated equal decrease in both positive and negative amplitudes of the waveform. In this situation, the Max pooling operation, the Min pooling operation, and the Average pooling operation stay unchanged, as shown in FIG. 66. Therefore, in this situation, the Learnable Pool can be applied to distinguish this event. For this example, the Learnable Pool can have a set of weights [0,0,−1,0,1,0,0,0], as shown in FIG. 67, and various decreases in amplitudes are readily discernible or identifiable via the Learnable Pool.

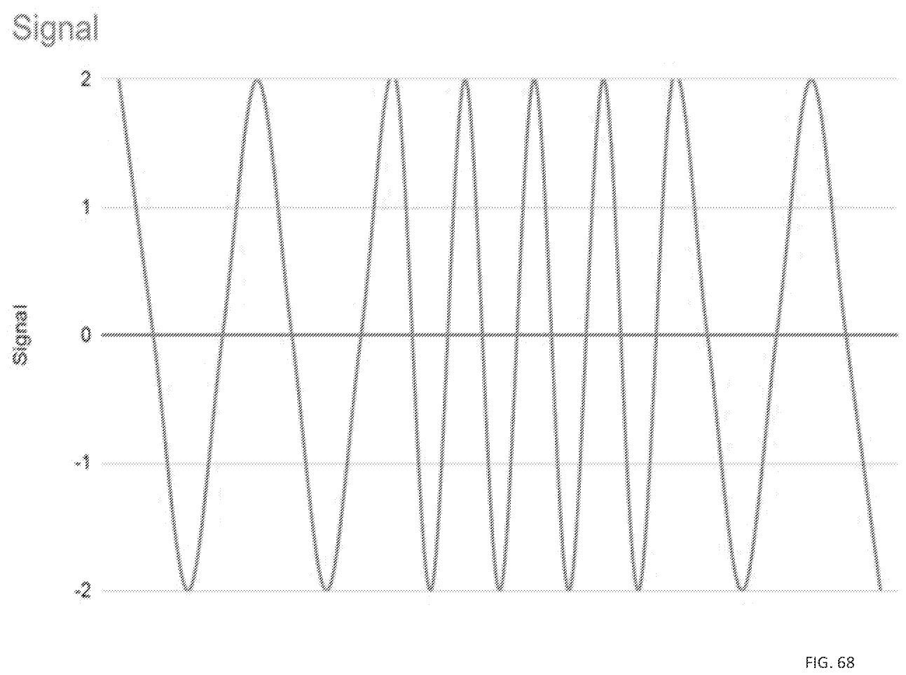

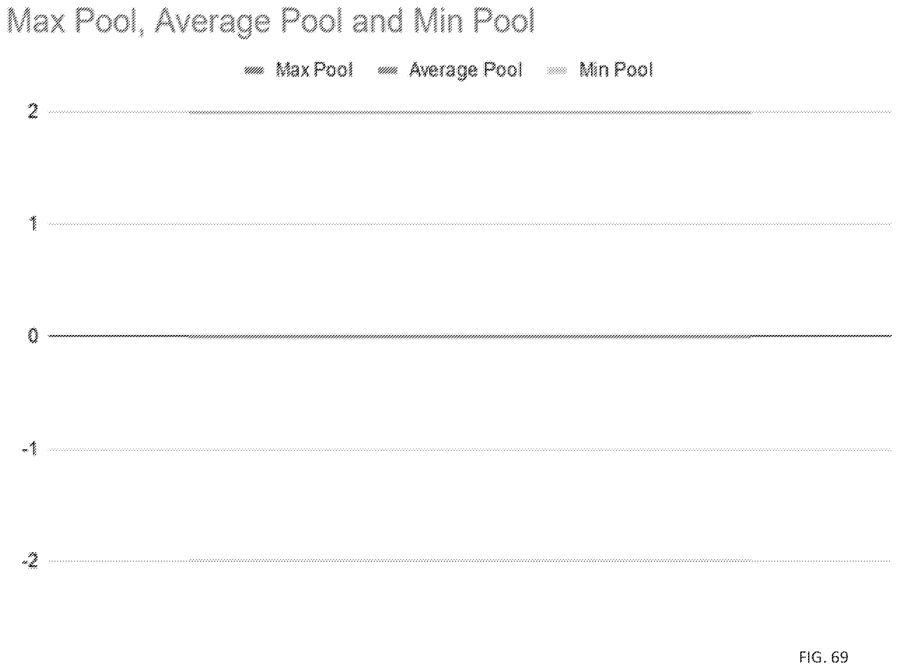

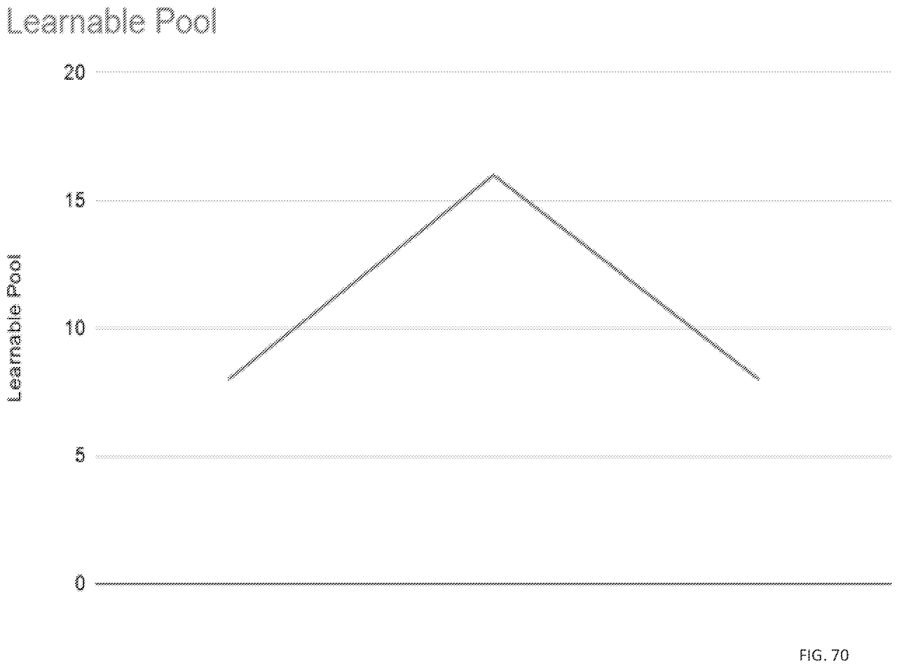

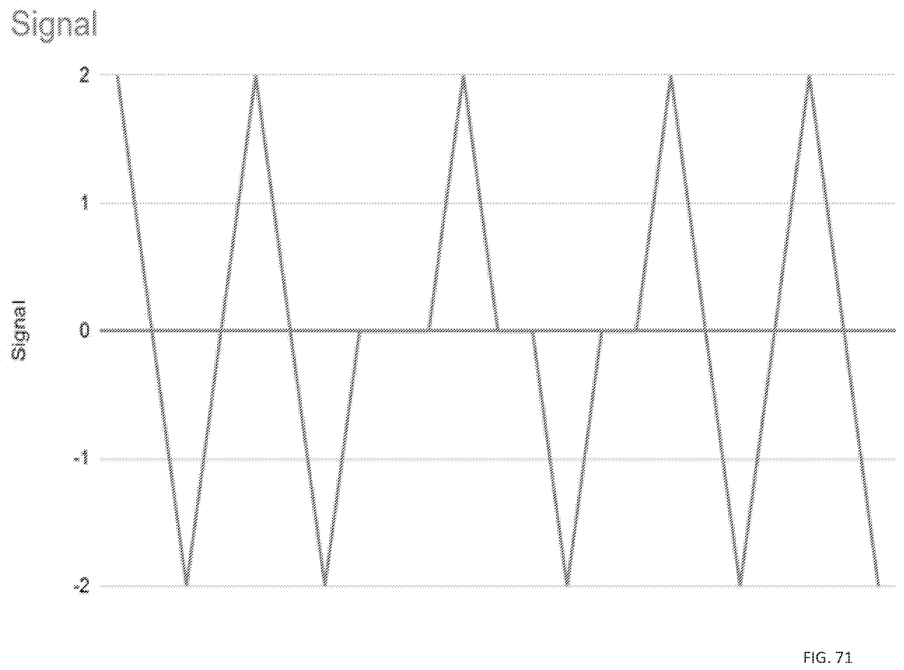

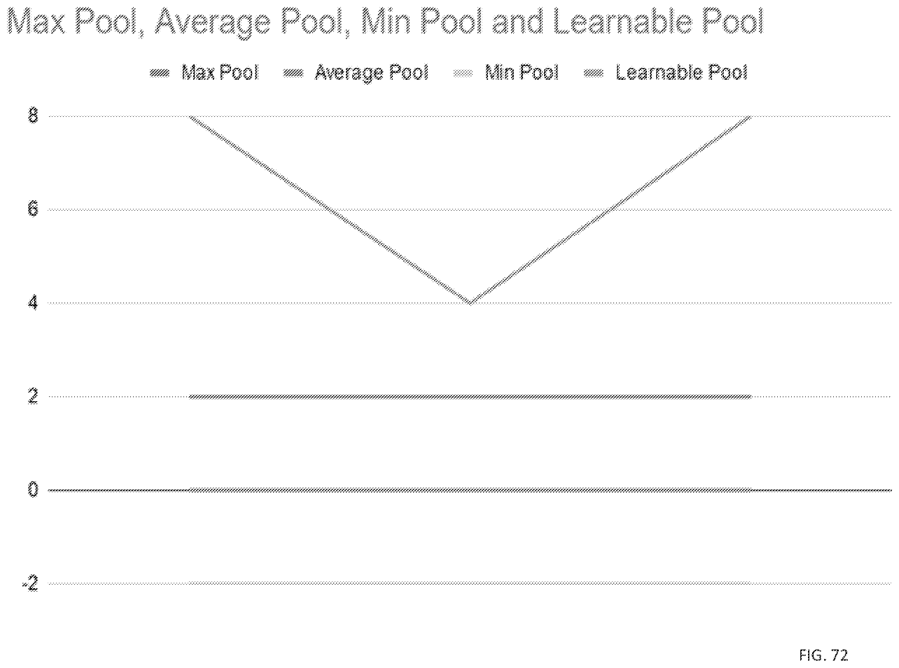

Another example of this would be waveforms increasing/decreasing in frequency, as shown in FIG. 68. Once again, the Min pooling operation, the Max pooling operation, and the Average pooling operation are unchanged, as shown in FIG. 69. However, with a learnable pool having a set of weight [1,−1,1,−1,1,−1,1,−1], then a change in frequency becomes readily discernible or identifiable, as shown in FIG. 70. Note that this same Learnable Pool can also work for a decrease in frequency, as shown in FIG. 71 and FIG. 72.

Various techniques, as disclosed herein, can be embodied or implemented in various ways. For example, one of such ways involves having some of these techniques be implemented as, performed by, or embodied within a layer (e.g., a pooling layer) of an ANN.

With respect to hyperparameters, as with all hyperparameters, these values are chosen by a user (e.g., a data scientist), with at least some aid of domain knowledge and experience, and tuned through typical experimentation. These parameters may not change during training or prediction time (although this may sometimes be possible).

With respect to downsample factors, note that a downsample factor is a ratio of an old data rate to a new desired data rate. For example, if a desired result of a downsampling process is ⅕th of an original data size, then the downsample factor is 5. The downsample factor can be a fixed value for a model.

With respect to Learnable Pools, at a minimum these techniques can require that the user chooses to employ at least one simple learnable pool. The simpler the pattern of the signal, the less complex the learnable pooling will need to be. As there is no upper limit to the complexity of the signals that the ANN is being employed to detect, there is also no upper limit to the number or complexity to the learnable pools that will be required to detect the signal. Typically, the available compute power and time available for learning (or other factors) enforces a practical limitation on the learnable pools. As with most other hyperparameters, data science best practices prescribes an experimental approach to discovering various optimal parameter values.

With respect to layer architecture, individually, in no particular order, and without regard to concurrency, the Max pooling operation, the Min pooling operation, the Average pooling operation, and Learnable Pools, according to the hyperparameters selected by the user, are all applied to a set of data (e.g., a sequence of data values). The application of these pools to the set data occurs, as disclosed herein. Therefore, combining various basic pools (e.g., Max, Min, Average) with learnable pools enables various technological advantages that are disclosed herein.

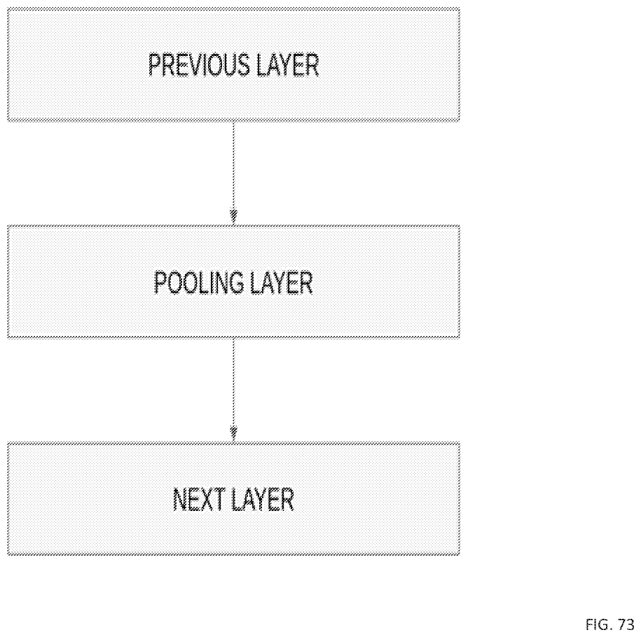

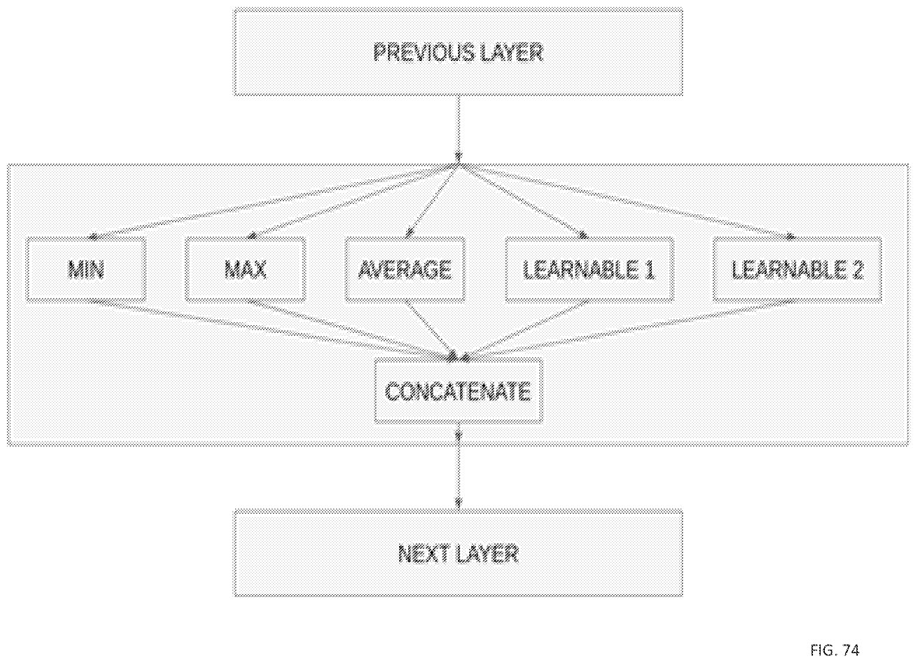

As shown in FIG. 73, an ANN has a set of layers, where some layers are preceded by some previous layers (e.g., an input layer, a hidden layer, a convolution layer, a recurrent layer) and are followed by some following layers (e.g., an output layer, a hidden layer, a convolution layer, a recurrent layer). When employing basic pooling layers (e.g., Max, Min, Average), a pooling layer would have a single output to pass to a next layer. Various techniques, as disclosed herein, employ several pools, operating in parallel on an input from a previous layer (e.g., the input is copied and those copies are fed into each pool). Each of those pools (e.g., Min, Max, Average, Learnable Pool 1, Learnable Pool 2) will have their own output. These outputs can be concatenated together (e.g., joining values or sets of data end-to-end) to form a single output, as shown in FIG. 74. This concatenated output may be treated as a standard ANN layer output, fit for use as input to any subsequent layers in a model as an ANN architecture written by the user. During training time, the learnable pools have their internal weights adjusted by a mechanism specified by the user that is used to adjust some, many, most, or all of weights of the model, as disclosed herein. The specific scheme to update the weights can vary. For example, the learnable pools can be plugged into some mechanism by which the learnable pool can learn to better fit themselves to best downsample the data (e.g., Stochastic Gradient Descent with Backpropagation, RMSprop optimizer, Adam optimizer, Evolutionary Optimization). For example, the learnable pool can be programmed to or a logic (e.g., an executable code, a function, an object) is programmed to cause the learnable pool to better fit itself to best downsample the input set of data based on a set of criteria.

With respect to variations, note that learnable pools can deprecate at least some technological need for one or more of the non-learnable pools over time, as shown in FIG. 75. Therefore, the user may choose to omit those redundant non-learnable pools to lower at least some compute cost of training. As such, various techniques, as disclosed herein, can be technologically beneficial to anyone wanting to train a deep learning model on data containing events with multiple discrete frequencies.

Note that this disclosure can be employed or adapted in context of any ANNs, whether stateful or non-stateful. For example, some of such ANNs include some of such types or subtypes including a long short-term memory (LSTM) ANN, a convolutional neural network (CNN) ANN, a convolutional LSTM ANN, a gated recurrent unit (GRU) ANN, or others, any of which can be stateful or non-stateful. Likewise, note that various examples and values used therein are illustrative and can vary, as needed, whether higher or lower. Moreover, note that various techniques, as disclosed herein, can be performed to maximize at least some utilization of a processing hardware device via computational parallelized processing (e.g., on a core basis, on a thread basis, on a system-on-chip basis). For example, the processing hardware device can include a central processing unit (CPU), a graphics processing unit (GPU), a system-on-chip (SOC), a tensor processing unit (TPU), or others, which can be configured for parallel processing (e.g., on a core basis, on a thread basis). For example, at least some device parallelization (e.g., spreading or distributing a model architecture across various physical devices) or at least some data parallelization (e.g., splitting or distributing data across various physical devices) can be applicable. For example, at least some device parallelization or at least some data parallelization can include processing (e.g., reading, modifying, copying, moving, sorting, organizing) of at least one pool in parallel simultaneously by multiple cores of the processing hardware device (e.g., CPU, GPU, TPU, SOC). Additionally, note that various techniques, as disclosed herein, can be performed on any data values (e.g., a word, a term, a phrase, a single voltage reading for a moment in time, a single point-in-time price of a financial security, a single point-in-time measurement, a single point-in-time biometric, a weather forecast, an exchange rate, a set of sales values, a set of sound wave values, a set of pixel values, or other data). For example, the data samples can contain the data values that are collected over time from a plurality of electrical leads (e.g., EEG leads) attached to a plurality of people (or suitable other mammalian species) or a plurality of thermometers measuring a plurality of environments or people (or other mammalian species) or a plurality of data channels of an electrical signal or from a sensor (e.g., a biometric sensor, an industrial sensor, a vehicular sensor). For example, the data values can be a plurality of temperature readings obtained from a plurality of indoor or outdoor environments or people. Note that data can include alphanumeric data, pixel data, or other data types. Similarly, note that various techniques, as disclosed herein, can be performed in a machine learning framework (e.g., TensorFlow, PyTorch, Microsoft Cognitive Toolkit).

Although various techniques, as disclosed herein, technologically improve ANNs (e.g., preserving signals for ANNs when downsampling), these techniques also can have various other real world and practical applications. One such example of occurs in a discrimination between a normal electroencephalogram and an abnormal electroencephalogram, where some of such electroencephalograms can include up to a 72 hours of 200 samples (e.g., floating-point values, whole values) per second or Hertz (Hz) distributed across 19 geographically-related channels (although other electroencephalogram types are possible which can differ in time period or sampling or channel amount). For example, an electroencephalogram can be read by a medical doctor (e.g., a neurologist) in order to diagnose a neurological condition (e.g., epilepsy, seizure disorder) or a neurological impact (e.g., a neurological activity in a COVID patient). However, since human interpretation techniques can vary (e.g., training, experience, inexperience, cognitive fatigue, skimming, compression), there may be some negative impact to accuracy of such interpretation. Likewise, there may be some electroencephalograms that may have variable lengths (e.g. from about 20 minutes to full 72 hours). In these types of electroencephalograms, each of the data samples can have about 1 billion data points (or more or less). For example, there may be over 50 terabytes of such electroencephalogram data files, which can include over 1 million hours of human-labeled electroencephalogram recordings. Accordingly, a signal that determines that a given data sample should be classified as abnormal may occur in less than a single second or just a few hundred of those 1 billion data points. Without various techniques, as disclosed herein, when reviewing this raw output, some events may be readily distinguishable. However, as explained previously, when an event's component sub-signals are further apart, an ANN has great technological difficulty in detecting the sub-signals. In other words, for a machine, some events are very technologically difficult to distinguish in raw formats. Through downsampling, though, this problem can be eliminated or minimized in order to help the machine to distinguish. However, when reviewing this raw output of this new downsampled signal, although some events are now readily distinguishable, other events have disappeared entirely. As such, given a dataset where events occur at frequencies which vary widely, various conventional data science downsampling methods are technologically deficient in their ability to preserve the signals for the ANN when downsampling. In contrast, when employing the techniques, as disclosed herein, a series of pooling operations, including learnable pools, preserve desired event presence after downsampling and makes those events evident, without resulting (or minimally) in the loss of desired events. For example, using the techniques, as disclosed herein, a computing machine (e.g., the server 104 or the client 106) can be programmed to complete an interpretation (e.g., classification, event detection, spike detection) of such electroencephalograms, with equivalent or higher level of accuracy as the medical doctor. The interpretation can be supplemented via various computer vision algorithms interpreting a contemporaneous video of a patient from whom these electroencephalograms are contemporaneously obtained (e.g., electrical leads), whether those cameras are patient-worn or positioned near the patient (e.g., within a house of the patient). For example, such interpretation can include object detection, object tracking, and other object actions, while or after these electroencephalograms are being collected from the patient in real-time. For example, at least some of the object actions can include anomaly detection, seizure detection, which can occur in combination with electroencephalogram capture (e.g., via an electrical lead). However, note that other real world and practical applications include image processing, video processing, text processing, financial pricing time based data (e.g., a stock price over time), temperature monitoring, sensor monitoring, electrical load monitoring, or other uses of data inputs that have extraordinarily long sequences (e.g., a 19 channel, 72 hour EEG recording sampled at 200 Hertz (Hz), which is 984,960,000 (nearly 1 billion) data points) that require a lower dimensional input, while lacking knowledge of the location of the relevant signals (e.g., extremely long sequences lacking signal localization). For example, regression, multi-class, multi-label, or other ANN technological problems can be improved with some of these data science techniques. What the applications will have in common are extraordinarily long sequences that require a lower dimensional input, while lacking knowledge of the location of the relevant signals.

Various techniques, as disclosed herein, can be used with various data science techniques to preserve signal in data inputs with moderate to high levels of variances in data sequence lengths for artificial neural network model training, as disclosed in U.S. Patent Application 63/027,269 ('269 patent application) and U.S. Patent Application 63/053,245 ('245 patent application), each of which is incorporated by reference herein as if copied and pasted herein. For example, the '269 patent application discloses various incorporated data science techniques can be helpful for dealing with time series or non-fixed-length time spans or other forms of discretized, parsed, or tokenized data. Some technological effects of utilizing these data science techniques can be technologically equivalent to getting more relevant training data, which can allow a model of a neural network (e.g., an RNN) to be trained to a high level of accuracy. Some of these data science techniques include a construction of a virtual batch, where at least some data samples are swapped in and out, and a technique of resetting a global state of a stateful RNN (or another ANN) that is sensitive to a state of the virtual batch in which only at least some state information relating to those swapped samples is reset in the virtual batch. For example, the technique for resetting the global state can reset various internal states relevant to new virtual data segments for various components of the stateful RNN (or another ANN). For example, the '245 patent application discloses various computing technologies for various data science techniques for ameliorating negative impacts of signals that are sparse in various data series for trainings of ANN models. These data science techniques can be helpful for dealing with time series or non-fixed-length time spans or other forms of discretized, parsed, or tokenized data. Some of the data science techniques can enable a process that ameliorates a negative impact of a sparse signal on a learning performance of an ANN model. This amelioration can occur by adjusting an impact of a computed loss on a learning process of an ANN on a sample-by-sample basis in such a way as to reflect a probability that the ANN model has seen a signal for that sample.

Various data samples, as disclosed herein, can include alphanumerics, whole or decimal or positive or negative numbers, text or words, symbols, or other data types. These data samples can be sourced from a single data source or a plurality of data sources as time series or non-fixed-length time spans or other forms of discretized, parsed, or tokenized data. Some of such data sources can include electrodes, sensors, motors, pumps, actuators, circuits, valves, receivers, transmitters, transceivers, processors, servers, industrial equipment, electrical energy loads, or other physical devices, whether positionally stationary (e.g., weather, indoor or outdoor climate, earthquake, traffic or transportation, fossil fuel or oil or gas, medical) or positionally mobile, whether land-based, marine-based, aerial-based, or satellite-based. Some examples of such data sensors can include an EEG lead, although other human or mammalian bioinformatic sensors, whether worn or implanted (e.g., head, neck, torso, spine, arms, legs, feet, fingers, toes) can be included. Some examples of such human or mammalian bioinformatics sensors can be embodied with medical devices or wearables. Some examples of such medical devices or wearables include headgear, headsets, headbands, head-mounted displays, hats, skullcaps, garments, bandages, sleeves, vests, patches, footwear, vests, or others. Some examples of various use cases involving such medical devices or wearables can include diagnosing, forecasting, preventing, or treating neurological conditions or disorders or events based on data samples from an EEG lead (or other bioinformatic sensors). Some examples of such neurological conditions or disorders or events include epilepsy, seizures, or others.

Various techniques, as disclosed herein, can be used for exceptionally large datasets with extremely long time sequences, as disclosed herein. For example, some of these data science techniques can be employed on ANNs having at least 100,000 of trainable parameters or can operate on datasets with at least 10,000 of examples, where each of such examples can have at least 10,000 of time steps each. For example, there can be at least tens or hundreds of epochs to train. For example, there can be ANNs with millions of trainable parameters, datasets with millions of examples, and time series with millions of examples.

In addition, features described with respect to certain example embodiments may be combined in or with various other example embodiments in any permutational or combinatorial manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

Although various embodiments have been depicted and described in detail herein, skilled artisans know that various modifications, additions, substitutions and the like can be made without departing from this disclosure. As such, these modifications, additions, substitutions and the like are considered to be within this disclosure.

What is claimed is:

1. A method of preserving signals for artificial neural networks when downsampling, the method comprising:
receiving, by a processor, a set of hyperparameters for a model of an artificial neural network (ANN) and a downsample factor for the model, wherein the ANN includes a first layer, a pooling layer, and a second layer, wherein the first layer feeds the pooling layer, wherein the pooling layer feeds the second layer, wherein the pooling layer is positioned between the first layer and the second layer, wherein the pooling layer contains a maximum pool, a minimum pool, an average pool, a learnable pool, and a concatenating function;
receiving, by the processor, within the pooling layer, an input set of data from the first layer;
forming, by the processor, within the pooling layer, a plurality of copies of the input set of data;
inputting, by the processor, within the pooling layer, the copies to each of the maximum pool, the minimum pool, the average pool, and the learnable pool according to the set of hyperparameters based on the downsample factor;
receiving, by the processor, within the pooling layer, a pooling output from each of the maximum pool, the minimum pool, the average pool, and the learnable pool;
inputting, by the processor, within the pooling layer, the pooling output from each of the maximum pool, the minimum pool, the average pool, and the learnable pool into the concatenating function such that the concatenating function outputs a concatenated output within the pooling layer formed based on the pooling output from each of the maximum pool, the minimum pool, the average pool, and the learnable pool;
inputting, by the processor, the concatenated output from the pooling layer into the second layer; and
taking, by the processor, an action based on the concatenated output being in the second layer.

2. The method of claim 1, wherein the learnable pool is a first learnable pool, wherein the pooling layer includes a set of learnable pools including the first learnable pool and a second learnable pool, wherein the copies are input into each of the maximum pool, the minimum pool, the average pool, the first learnable pool, and the second learnable pool according to the set of hyperparameters based on the downsample factor, wherein the pooling output is received from each of the maximum pool, the minimum pool, the average pool, the first learnable pool, and the second learnable pool.

3. The method of claim 1, wherein the learnable pool is executed concurrent with at least one of the maximum pool, the minimum pool, or the average pool within the pooling layer on respective copies of the input set of data.

4. The method of claim 3, wherein the learnable pool is executed concurrent with at least two of the maximum pool, the minimum pool, or the average pool within the pooling layer on respective copies of the input set of data.

5. The method of claim 4, wherein the learnable pool is executed concurrent with each of the maximum pool, the minimum pool, or the average pool within the pooling layer on respective copies of the input set of data.

6. The method of claim 1, wherein the concatenated output from the pooling layer is a single output.

7. The method of claim 1, wherein the learnable pool is programmed to or a logic is programmed to cause the learnable pool to better fit itself to best downsample the input set of data based on a set of criteria.

8. The method of claim 1, wherein the learnable pool includes a convolutional neuron with a learnable activation function that are programmed such that the learnable pool processes the copy according to the set of hyperparameters based on the downsample factor, wherein the convolutional neuron has a stride and a kernel size each set according to how the learnable pool is sized.

9. The method of claim 1, wherein the learnable pool includes a convolutional neuron that is convolved such that the learnable pool processes the copy according to the set of hyperparameters based on the downsample factor, wherein convolutional neuron is programmed to generate a set of values that are condensed using global max pooling operation.

10. The method of claim 1, wherein the learnable pool includes a recurrent neuron that is convolved such that the learnable pool processes the copy according to the set of hyperparameters based on the downsample factor, wherein the recurrent neuron is programmed to run within a designated pooling area and to generate a value that is used as the value of the learnable pool.

11. A system of preserving signals for artificial neural networks when downsampling, the system comprising:
a server programmed to:
receive a set of hyperparameters for a model of an artificial neural network (ANN) and a downsample factor for the model, wherein the ANN includes a first layer, a pooling layer, and a second layer, wherein the first layer feeds the pooling layer, wherein the pooling layer feeds the second layer, wherein the pooling layer is positioned between the first layer and the second layer, wherein the pooling layer contains a maximum pool, a minimum pool, an average pool, a learnable pool, and a concatenating function;
receive, within the pooling layer, an input set of data from the first layer;
form, within the pooling layer, a plurality of copies of the input set of data;
input, within the pooling layer, the copies to each of the maximum pool, the minimum pool, the average pool, and the learnable pool according to the set of hyperparameters based on the downsample factor;
receive, within the pooling layer, a pooling output from each of the maximum pool, the minimum pool, the average pool, and the learnable pool;
input, within the pooling layer, the pooling output from each of the maximum pool, the minimum pool, the average pool, and the learnable pool into the concatenating function such that the concatenating function outputs a concatenated output within the pooling layer formed based on the pooling output from each of the maximum pool, the minimum pool, the average pool, and the learnable pool;
input, the concatenated output from the pooling layer into the second layer; and
take, an action based on the concatenated output being in the second layer.

12. The system of claim 11, wherein the learnable pool is a first learnable pool, wherein the pooling layer includes a set of learnable pools including the first learnable pool and a second learnable pool, wherein the copies are input into each of the maximum pool, the minimum pool, the average pool, the first learnable pool, and the second learnable pool according to the set of hyperparameters based on the downsample factor, wherein the pooling output is received from each of the maximum pool, the minimum pool, the average pool, the first learnable pool, and the second learnable pool.

13. The system of claim 11, wherein the learnable pool is executed concurrent with at least one of the maximum pool, the minimum pool, or the average pool within the pooling layer on respective copies of the input set of data.

14. The system of claim 13, wherein the learnable pool is executed concurrent with at least two of the maximum pool, the minimum pool, or the average pool within the pooling layer on respective copies of the input set of data.

15. The system of claim 14, wherein the learnable pool is executed concurrent with each of the maximum pool, the minimum pool, or the average pool within the pooling layer on respective copies of the input set of data.

16. The system of claim 11, wherein the concatenated output from the pooling layer is a single output.

17. The system of claim 11, wherein the learnable pool is programmed to or a logic is programmed to cause the learnable pool to better fit itself to best downsample the input set of data based on a set of criteria.

18. The system of claim 11, wherein the learnable pool includes a convolutional neuron with a learnable activation function that are programmed such that the learnable pool processes the copy according to the set of hyperparameters based on the downsample factor, wherein the convolutional neuron has a stride and a kernel size each set according to how the learnable pool is sized.

19. The system of claim 11, wherein the learnable pool includes a convolutional neuron that is convolved such that the learnable pool processes the copy according to the set of hyperparameters based on the downsample factor, wherein convolutional neuron is programmed to generate a set of values that are condensed using global max pooling operation.

20. The system of claim 11, wherein the learnable pool includes a recurrent neuron that is convolved such that the learnable pool processes the copy according to the set of hyperparameters based on the downsample factor, wherein the recurrent neuron is programmed to run within a designated pooling area and to generate a value that is used as the value of the learnable pool.
